(19) United States
(12) Patent Application Publication
(10) Pub. No.: US 2012/0074793 A1
(43) Pub. Date: Mar. 29, 2012

(54) PERIPHERAL DEVICE AND CONTROL METHOD THEREOF

(75) Inventors: Nobuhiro TAMURA, Nagoya-shi (JP); Masao Yamaguchi, Nagoya-shi (JP)

(73) Assignee: Buffalo Inc., Nagoya-shi (JP)

(21) Appl. No.: 13/235,440

(22) Filed: Sep. 18, 2011

(30) Foreign Application Priority Data
Sep. 24, 2010 (JP) 2010-213057

(51) Int. Cl. H01H 47/00

(52) U.S. Cl. 307/130

(57) ABSTRACT

There is provided a peripheral device capable of being connected to a host device through a connection cable including a power line. This peripheral device comprises: a first power terminal capable of being connected to the power line of the connection cable; a power circuit connected to a second power terminal different from the first power terminal and for supplying power to an internal circuit; a start signal generating circuit for generating a start signal causing the power circuit to start supplying power to the internal circuit, when power has been supplied to the first power terminal through the connection cable; and a feedback circuit for allowing the start signal to remain activated when power has been supplied to the internal circuit from the power circuit.

### CROSS-REFERENCES TO RELATED APPLICATIONS

This application claims the benefit of Japanese Patent Application No. 2010-213057 filed on Sep. 24, 2010, the entire disclosure of which is incorporated herein by reference.

### BACKGROUND OF THE INVENTION

1. Field of the Invention

The present invention relates to a peripheral device disposed on a periphery of a TV, a personal computer or the like and a control method thereof.

2. Description of Related Art

There has been disclosed a technique allowing a broadcast receiving device and a recording/reproducing device connected thereto to be synchronized with one another in terms of power supply (e.g., Japanese Unexamined Patent Application Publication No. 2007-43624)

According to the aforementioned conventional technique, the recording/reproducing device is powered on/off by means of a command outputted from the broadcast receiving device. Further, the broadcast receiving device and the recording/reproducing device need to share a common protocol (e.g., a USB protocol) in order to allow the aforementioned command to be transmitted. Same configuration is required when synchronizing a host device with a peripheral device in terms of power supply.

It is an object of the present invention to provide: a peripheral device capable of being synchronized with a host device such as a TV, a personal computer or the like in terms of power supply, independently from the kinds of protocols and the corresponding devices; and a control method thereof. Further, it is also an object of the present invention to provide a peripheral device capable of being independently powered on/off even when connected to a host device, and a control method thereof.

### SUMMARY OF THE INVENTION

A peripheral device of the present invention can be connected to a host device through a connection cable including a power line. Particularly, the peripheral device of the present invention comprises: a first power terminal capable of being connected to the power line of the connection cable; a power circuit connected to a second power terminal different from the first power terminal and for supplying power to an internal circuit; a first start signal generating circuit for generating a start signal causing the power circuit to start supplying power to the internal circuit, when power has been supplied to the first power terminal through the connection cable; and a feedback circuit for allowing the start signal to remain activated when power has been supplied to the internal circuit from the power circuit.

According to the present invention, the peripheral device can be started along with the host device when the corresponding host device is started, due to power supplied from the power line of the connection cable at that time and independently from the kinds of protocols and the corresponding devices. Further, the peripheral device thus started can remain started thereafter.

Further, the peripheral device of the present invention may comprise: a power supply detection circuit for detecting a power supply to the first power terminal; and a power supply shutdown circuit for stopping the power circuit from supplying power to the internal circuit when the power supply detection circuit has detected that the first power terminal is no longer being supplied with power.

Furthermore, the peripheral device of the present invention may comprise: a power switch; and a second start signal generating circuit for generating a start signal causing the power circuit to start supplying power to the internal circuit, when the power switch has been turned on under a condition in which no power is being supplied to the first power terminal through the connection cable.

Furthermore, the peripheral device of the present invention may comprise: a power switch-off detection circuit for detecting that the power switch is turned off; and a power supply shutdown circuit for stopping the power circuit from supplying power to the internal circuit, when the power switch-off detection circuit has detected that the power switch is turned off under the condition in which no power is being supplied to the first power terminal through the connection cable.

Furthermore, the peripheral device of the present invention may comprise: a power switch-off detection circuit for detecting that the power switch is turned off; and a power supply shutdown circuit for stopping the power circuit from supplying power to the internal circuit, when the power switch-off detection circuit has detected that the power switch is turned off under a condition in which power is being supplied to the first power terminal through the connection cable.

Furthermore, the peripheral device of the present invention may comprise a changeover circuit for either allowing or not allowing the power supply to the first power terminal to be detected.

Furthermore, the peripheral device of the present invention may comprise: a rewritable nonvolatile memory; and a writing detection unit for detecting whether or not the rewritable nonvolatile memory is being rewritten, in which the power supply shutdown circuit serves to restrict an operation of the feedback circuit and stop the power circuit from supplying power to the internal circuit after the rewritable nonvolatile memory has been rewritten.

Furthermore, a peripheral device of the present invention can be connected to a host device through a connection cable including a power line. Particularly, the peripheral device of the present invention comprises: a first power terminal capable of being connected to the power line of the connection cable; a power circuit connected to a second power terminal different from the first power terminal and for supplying power to an internal circuit; and a control unit for causing the power circuit to start supplying power to the internal circuit when power has been supplied to the first power terminal through the connection cable, and for stopping the power circuit from supplying power to the internal circuit when the first power terminal is no longer being supplied with power.

According to the present invention, the peripheral device can be powered on/off in synchronization with the host device started, due to power supplied from the power line of the connection cable and independently from the kinds of protocols and the corresponding devices.

Here, the first power terminal may be a USB power connector.

Further, the peripheral device may be any one of an external memory device, a media player, a network recorder, a network communication device, a tuner, a Network Attached Storage and a set-top box.

A control method for controlling power on/off of a peripheral device capable of being connected to a host device through a connection cable including a power line, comprises: a step of supplying power to a first power terminal of the peripheral device through the connection cable; a step of generating a start signal causing a power circuit of the peripheral device to start supplying power to an internal circuit of the peripheral device, when power has been supplied to the first power terminal, such power circuit being connected to a second power terminal different from the first power terminal; a step of allowing the power circuit of the peripheral device to start supplying power to the internal circuit of the peripheral device by means of the start signal; and a step of allowing the start signal to remain activated when power has been supplied to the internal circuit from the power circuit.

According to the present invention, the peripheral device can be started along with the host device when the corresponding host device is started, due to power supplied from the power line of the connection cable at that time and independently from the kinds of protocols and the corresponding devices. Further, the peripheral device thus started can remain started thereafter.

The present invention can be carried out in various modes. Particularly, other than the peripheral device, the control method thereof can also be carried out in various modes. Further, the present invention can also be applied to a control program of the peripheral device and a storage medium in which the corresponding program is stored. As for the peripheral device, there can be employed a router, a NAS (Network Attached Storage), a wireless hub media server, a device server, a print server, a digital photo frame, a network camera, a network recorder or the like.

### BRIEF DESCRIPTION OF THE DRAWINGS

FIG. 1 is a diagram showing a configuration of a network communication system employing a wireless Ethernet converter of a first embodiment of the present invention.

FIG. 2 is a part of a functional block diagram of the wireless Ethernet converter of the first embodiment of the present invention.

FIG. 3 is a diagram showing a section of a circuit of the wireless Ethernet converter of the first embodiment.

FIG. 4 is a flow chart describing a type of Vbus trigger start-up under a condition of Vbus-synchronization.

FIG. 5 is a timing chart describing this type of Vbus trigger start-up under the condition of Vbus-synchronization.

FIG. 6 is a flow chart describing a type of start-up of the wireless Ethernet converter, effected by a power switch under the condition of Vbus-synchronization.

FIG. 7 is a timing chart describing this type of start-up of the wireless Ethernet converter, effected by the power switch under the condition of Vbus-synchronization.

FIG. 8 is a flow chart showing how the wireless Ethernet converter is powered off by turning off a Vbus power under the condition of Vbus-synchronization.

FIG. 9 is a timing chart showing how the wireless Ethernet converter is powered off by turning off the Vbus power under the condition of Vbus-synchronization.

FIG. 10 is a flowchart showing how the wireless Ethernet converter is powered off when Vbus is at L level under the condition of Vbus-synchronization.

FIG. 11 is a timing chart showing how the wireless Ethernet converter is powered off when Vbus is at L level under the condition of Vbus-synchronization.

FIG. 12 is a flowchart showing an operation of the wireless Ethernet converter when the power switch is turned off with Vbus being at H level under the condition of Vbus-synchronization.

FIG. 13 is a timing chart showing this operation of the wireless Ethernet converter when the power switch is turned off with Vbus being at H level under the condition of Vbus-synchronization.

FIG. 14 is a diagram showing a section of a circuit of the wireless Ethernet converter of the first embodiment operated under a condition of Vbus non-synchronization.

FIG. 15A is a chart describing behaviors of a power supply shutdown signal GPIO1, a power SW supervisory signal /GPIO2 and a Vbus supervisory signal /GPIO3, when the wireless Ethernet converter is powered on.

FIG. 15B is a chart describing behaviors of the power supply shutdown signal GPIO1, the power SW supervisory signal /GPIO2 and the Vbus supervisory signal /GPIO3, when the wireless Ethernet converter is powered off.

FIG. 16 is a diagram showing another configuration of a start signal generating circuit.

FIG. 17 is a diagram showing a section of a circuit of a wireless Ethernet converter of a second embodiment of the present invention.

FIG. 18 is an operation flowchart of the second embodiment.

FIG. 19 is a timing chart of the second embodiment.

FIG. 20 is an operation flowchart of the second embodiment.

FIG. 21 is a timing chart of the second embodiment.

FIG. 22 is a diagram showing correlations among a signal SWout, a signal Vbusout, a power conservation signal GPIO and an enable signal Senable.

FIG. 23 is a diagram showing a modified embodiment of the second embodiment.

FIG. 24 is a diagram showing a third embodiment of the present invention.

### DETAILED DESCRIPTION OF THE INVENTION

### First Embodiment

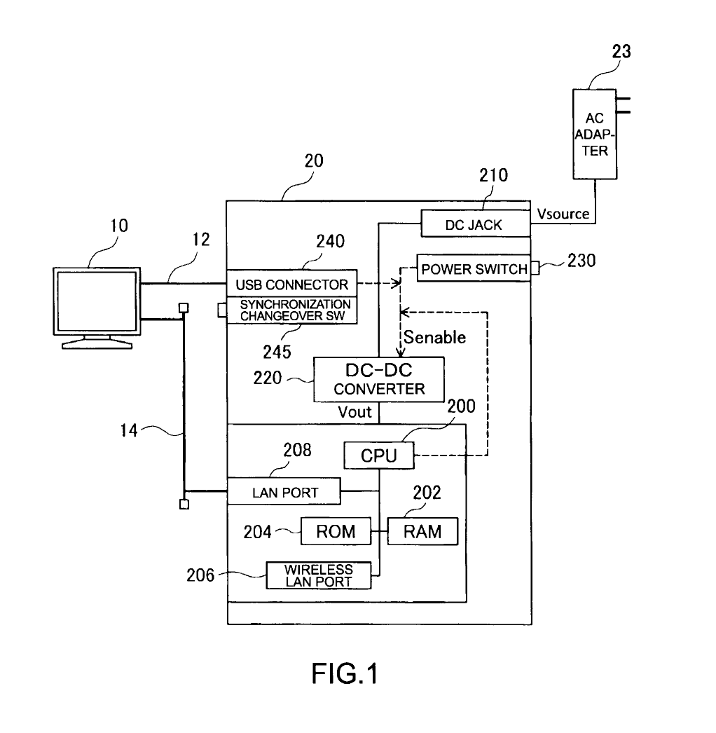

FIG. 1 is a diagram showing a configuration of a network communication system to which a first embodiment of the present invention is applied. The network communication system includes: a TV 10; a wireless Ethernet converter 20 which is the first embodiment of the present invention (employed as a peripheral device, and “Ethernet” is a registered trademark); and an AC adapter 23. The wireless Ethernet converter 20 includes: a CPU (Central Processing Unit) 200; a RAM (Random Access Memory) 202, a ROM (Read Only Memory) 204; a wireless LAN (Local Access Network) port 206; a LAN port 208; a DC (Direct Current) jack 210; a DC-DC converter 220; a power switch 230; a universal serial bus connector 240 (“universal serial bus” is referred to as “USB,” hereunder); and a USB-interlocking changeover switch 245.

The TV 10 is connected to the LAN port 208 of the wireless Ethernet converter 20 through a LAN cable 14. Signal exchange between the TV 10 and the wireless Ethernet converter 20 takes place through the corresponding LAN cable 14. Particularly, the signal exchange between the TV 10 and the wireless Ethernet converter 20 may be effected based on, for example, IEEE 802.3 (The Institute of Electrical and Electronics Engineers). Actually, signal exchange with the wireless Ethernet converter 20 may be effected through the wireless LAN port 206 instead of the LAN cable 14. In this case, the LAN cable 14 does not have to be provided. Signal exchange between the TV 10 and the wireless Ethernet converter 20 through the wireless LAN port 206 may be effected based on, for example, IEEE 802.11.

Further, the TV 10 is connected to the USB connector 240 of the wireless Ethernet converter 20 through a USB cable 12. In general, the USB cable 12 has a Vbus line, a D+ line, a D− line and a GND line. According to the present embodiment, the signal exchange between the TV 10 and the wireless Ethernet converter 20 is effected without using the D+ line and D− line serving as data lines, but using only the Vbus line and the GND line. However, the signal exchange with the wireless Ethernet converter 20 may be effected even when the D+ line and D− line are included.

The AC (Alternating Current) adapter 23 is connected to the DC jack 210 of the wireless Ethernet converter 20. In general, “DC jack” is the term used to refer to a female terminal into which a DC plug (male terminal) is to be plugged, such DC plug being an output terminal of an AC adapter. In this sense, the term “DC jack” is used in the present embodiment. The AC adapter 23 serves to covert a household alternating current (AC) power supply into a direct current (DC) power supply with a voltage Vsource, and provide the corresponding direct current power supply to the wireless Ethernet converter 20 through the DC jack 210. The DC-DC converter 220 is connected to the DC jack 210, and serves to step down a voltage of the direct current power supply provided to the DC jack 210 so as to provide a power supply with a voltage Vout to the CPU 200, the RAM 202, the ROM 204, the wireless LAN port 206 and the LAN port 208. Here, a step-down operation of the DC-DC converter 220 is activated by an enable signal Senable. When the enable signal Senable is active, the aforementioned power supply is provided to the CPU 200, the RAM 202, the ROM 204, the wireless LAN port 206 and the LAN port 208. When the enable signal is inactive, the aforementioned power supply ceases to be provided to the CPU 200, the RAM 202, the ROM 204, the wireless LAN port 206 and the LAN port 208. According to the present embodiment, the enable signal Senable is active when it is at H level and inactive when it is at L level.

The CPU 200 serves to control an operation of the wireless Ethernet converter 20. Further, the CPU 200 serves to control the enable signal Senable for activating the DC-DC converter 220. The ROM 204 has a firmware of the wireless Ethernet converter 20 stored therein. The ROM 204 is composed of a rewritable nonvolatile memory. As for an rewritable nonvolatile memory, there can be employed an EEPROM (Electrically Erasable Programmable Read Only Memory), a flash memory, a ferroelectric memory, a magnetoresistive memory or the like.

The USB-interlocking changeover switch 245 serves to turn on/off the wireless Ethernet converter 20 depending on whether or not a bus power is being applied to the USB connector 240. Namely, according to the present embodiment, when the USB-interlocking changeover switch 245 is synchronized with USB, the wireless Ethernet converter 20 is turned on upon the application of the bus power to the USB connector 240 (H), and is turned off as the bus power ceases to be applied to the USB connector 240 (L). However, the wireless Ethernet converter 20 can also be turned on/off by means of the power switch 230. Particularly, when the USB-interlocking changeover switch 245 is not synchronized with USB, the wireless Ethernet converter 20 is turned on/off by means of the power switch 230, independently from whether or not the bus power is being applied to the USB connector 240.

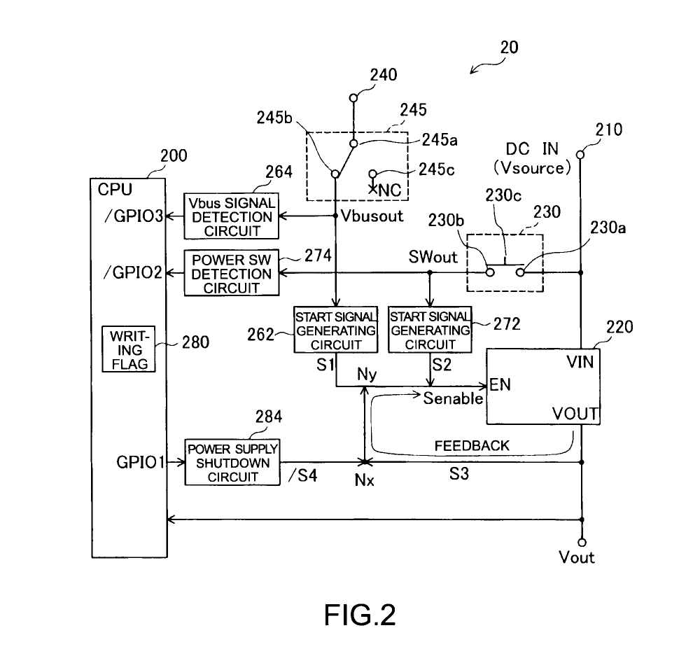

FIG. 2 is a part of a functional block diagram of the wireless Ethernet converter 20 of the present embodiment. The wireless Ethernet converter 20 further includes: start signal generating circuits 262, 272; a Vbus signal detection circuit 264; a power switch detection circuit 274; and a power supply shutdown circuit 284, other than the aforementioned DC jack 210, the DC-DC converter 220, the power switch 230, the USB connector 240 and the USB-interlocking changeover switch 245, shown in FIG. 1.

The USB-interlocking changeover switch 245 has an input terminal 245a and output terminals 245b, 245c. Specifically, the USB-interlocking changeover switch 245 is a changeover switch allowing an input into the input terminal 245a to be outputted from either the output terminal 245b or the output terminal 245c. According to the present embodiment, the input terminal 245a is connected to the USB connector 240, and the output terminal 245b is connected to both the start signal generating circuit 262 and the Vbus signal detection circuit 264. Configuration examples of the start signal generating circuit 262 and the Vbus signal detection circuit 264 are described later. The output terminal 245c is not connected to any of the aforementioned parts (indicated as NC (Non connection) in FIG. 2). In the present embodiment, an output signal from the output terminal 245b is referred to as a “signal Vbusout.” Such signal Vbusout is synchronized with a bus power output of the TV 10.

The power switch 230 includes an input terminal 230a, an output terminal 230b and a power button 230c. The power switch 230 is preferably a momentary action switch having an input terminal and an output terminal. Specifically, it is preferred that the input terminal 230a and the output terminal 230b are conductively connected to one another only when the power button 230c is being pushed. However, the power switch 230 may also be an alternate switch. Specifically, the power switch 230 may be an on/off changeover switch conductively connecting the input terminal 230a to the output terminal 230b once the power button 230c has been pushed, and conductively disconnecting the input terminal 230a and the output terminal 230b from each other as the power button 230c is pushed again. The input terminal 230a is connected to the DC jack 210, and the output terminal 230b is connected to both the start signal generating circuit 272 and the power switch detection circuit 274. Configurations of the start signal generating circuit 272 and the power switch detection circuit 274 are described later. In the present embodiment, an output signal from the output terminal 230b is referred to as a “signal SWout.”

The start signal generating circuit 262 serves to output a Vbus start signal S1, and the start signal generating circuit 272 serves to output a power SW start signal S2. Here, an output from the start signal generating circuit 262 and an output from the start signal generating circuit 272 interact with one another at a node Ny. Particularly, although the Vbus start signal S1 and the power SW start signal S2 collide with one another at the node Ny, the start signal generating circuit 262 is not influenced by the power SW start signal S2, and the start signal generating circuit 272 is not influenced by the Vbus start signal S1. Such a kind of configuration is described later. A signal at the node Ny is inputted into an EN terminal of the DC-DC converter 220, as the enable signal Senable.

The DC-DC converter 220 includes the EN terminal, a VIN terminal and a VOUT terminal. The VIN terminal is connected to the DC jack 210. The VOUT terminal is connected to a power terminal (not shown) of an internal circuit (i.e. the CPU 200, the RAM 202, the RAM 204, the wireless LAN port 206 and the LAN port 208). When an activated enable signal Senable (H) is being inputted into the EN terminal of the DC-DC converter 220, the DC-DC converter 220 serves to convert the voltage Vsource inputted into the VIN terminal so as to output the voltage Vout from the VOUT terminal. According to the present embodiment, the VOUT terminal is connected to the node Ny through a node Nx. Here, in the present embodiment, a signal supplied from the VOUT terminal to the node Ny through the node Nx is referred to as a “loop-back signal S3.” A feedback is effected by the loop-back signal S3 with the enable signal Senable of H level being inputted into the EN terminal and the voltage Vout being outputted from the VOUT terminal, thus allowing the enable signal Senable to remain activated (H).

The Vbus signal detection circuit 264 receives the signal Vbusout and serves to output a Vbus supervisory signal /GPIO3. The Vbus supervisory signal /GPIO3 is then inputted into the CPU 200. The power switch detection circuit 274 receives the signal SWout and serves to output a power SW supervisory signal /GPIO2. The power SW supervisory signal /GPIO2 is then inputted into the CPU 200. Here, the symbol “/” in the name of each signal denotes an active-low state. Namely, the corresponding signals are inactive when they are at H level and active when they are at L level.

The CPU 200 serves to activate a power supply shutdown signal GPIO1 (L to H) when the power SW supervisory signal /GPIO2 and the Vbus supervisory signal /GPIO3 have exhibited given behaviors. If the ROM 204 is having the firmware rewritten thereon, the CPU 200 will activate the power supply shutdown signal GPIO1 after the corresponding firmware has been rewritten on the ROM 204. Further, the CPU 200 actives a writing flag 280 when the firmware is being rewritten. Accordingly, the CPU 200 can easily determine whether or not the firmware is being rewritten, due to the presence of the writing flag 280 indicating that the firmware is being rewritten. Namely, the CPU 200 determines that the firmware is being rewritten if the writing flag 280 is activated, and that the firmware is not being rewritten if the writing flag 280 is not activated.

The power supply shutdown circuit 284 serves to output a power supply shutdown signal /S4 (L when activated) to the node Nx, upon receiving the power supply shutdown signal GPIO1 from the CPU 200. Here, the loop-back signal S3 and the power supply shutdown signal /S4 collide with one another at node Nx. However, the power supply shutdown circuit 284 is so configured that even when the loop-back signal S3 is at H level, the node Nx reaches L level as long as the power supply shutdown signal /S4 is at L level. According to the present embodiment, when both the Vbus start signal S1 and the power SW start signal S2 are inactive, the CPU 200 serves to input the power supply shutdown signal GPIO1 into the power supply shutdown circuit 284 so as to activate the power supply shutdown signal /S4. Next, with both the node Nx and the node Ny being at L level, the enable signal Senable is inactivated so as to stop the voltage Vout from being outputted from the VOUT terminal. In this way, the loop-back signal S3 is inactivated (L), thereby causing a feedback reflecting this condition to take place, and thus allowing the enable signal Senable to remain inactivated (L).

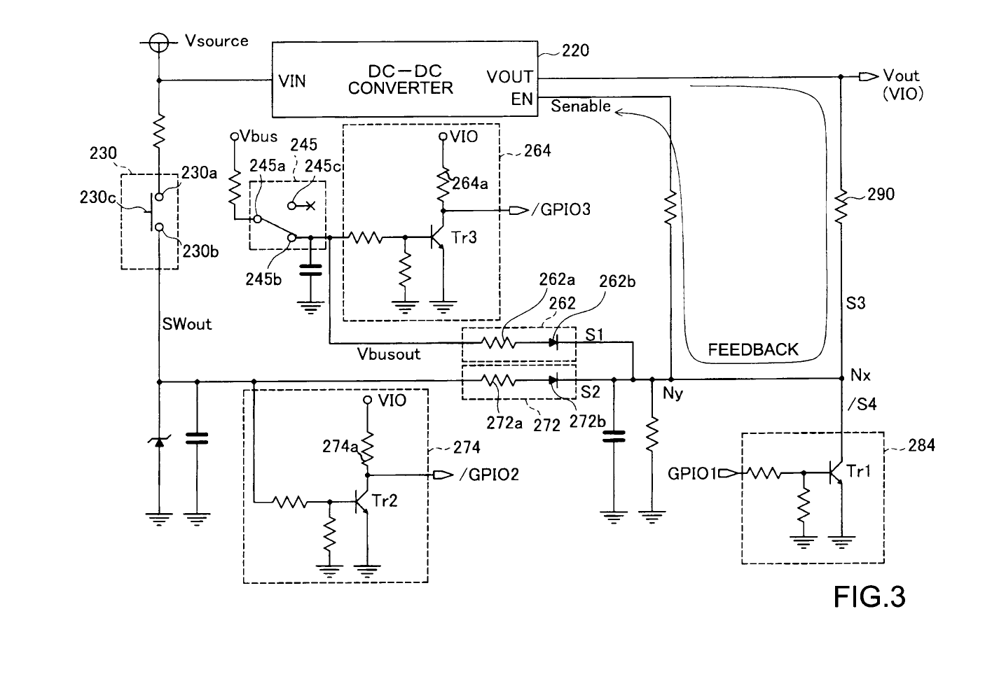

FIG. 3 is a diagram showing a section of a circuit of the wireless Ethernet converter 20 of the present embodiment. The start signal generating circuit 262 includes a resistor 262a and a diode 262b. A cathode of the diode 262b is connected to a node Ny side so as to pass an activated signal in the start signal generating circuit 262 in one direction. Accordingly, when the signal Vbusout has been transited to H level, the Vbus start signal S1 is also transited to H level. However, the signal Vbusout is not transited to H level, even when the Vbus start signal S1 has been transited to H level. Similarly, the start signal generating circuit 272 includes a resistor 272a and a diode 272b. The cathode of the diode 272b is also connected to the node Ny side. Therefore, the power SW start signal S2 is transited to H level when the signal SWout has been transited to H level. However, the signal SWout is not transited to H level, even when the power SW start signal S2 has been transited to H level.

The Vbus signal detection circuit 264 includes a transistor Tr3 and a resistor 264a. An emitter of the transistor Tr3 is connected to the ground, and a collector thereof is connected to an internal power supply VIO through a resistor 264a. The internal power supply VIO is connected to the output terminal VOUT of the DC-DC converter 220. The Vbus supervisory signal /GPIO3 is outputted from a connecting point of the collector of the transistor Tr3 and the resistor 264a. The signal Vbusout is inputted into a base of the transistor Tr3. When the signal Vbusout is at H level, a base-emitter current of the transistor Tr3 (P-N forward current) is caused to flow in the Vbus signal detection circuit 264. Further, the flow of the base-emitter current of the transistor Tr3 causes a collector-emitter current of the transistor Tr3 to flow, and the Vbus supervisory signal /GPIO3 then reaches L level due to a voltage drop caused by the resistor 264a. In contrast, the collector-emitter current of the transistor Tr3 is not caused to flow when the signal Vbusout is at L level, thus allowing the Vbus supervisory signal /GPIO3 to reach H level.

Similarly, the power switch detection circuit 274 includes a transistor Tr2 and a resistor 274a. The signal SWout is inputted into a base of the transistor Tr2, and the power SW supervisory signal /GPIO2 is outputted from a collector thereof. The power switch detection circuit 274 operates in the same way as that of the Vbus signal detection circuit 264.

The power supply shutdown circuit 284 includes a transistor Tr1. A resistor 290 is provided between a collector of the transistor Tr1 and the output terminal VOUT of the DC-DC converter. The power supply shutdown signal GPIO1 is inputted into a base of the transistor Tr1, and the power supply shutdown signal /S4 is outputted from a collector thereof. When the power supply shutdown signal GPIO1 is at H level, a base-emitter current of the transistor Tr1 is caused to flow. The flow of the base-emitter current of the transistor Tr1 causes a collector-emitter current of the transistor Tr1 to flow, and the power supply shutdown signal /S4 is then transited to L level due to a voltage drop caused by the resistor 290. Here, the enable signal Senable is also transited to L level when both the Vbus start signal S1 and the power SW start signal S2 are at L level. In addition, the CPU 200 outputs the power supply shutdown signal GPIO1 of H level, when the power switch 230 and the bus power are turned off. Accordingly, both the Vbus start signal S1 and the power SW start signal S2 are at L level. When the enable signal Senable is inactivated, the output from the output terminal VOUT of the DC-DC converter 220 is ceased. In other words, the voltage Vout reaches L level at that time. This voltage Vout is then fed back to the enable signal Senalbe as the loop-back signal S3. In this way, the enable signal Senable is allowed to remain inactivated (L), and the output from the output terminal VOUT of the DC-DC converter 220 remains ceased.

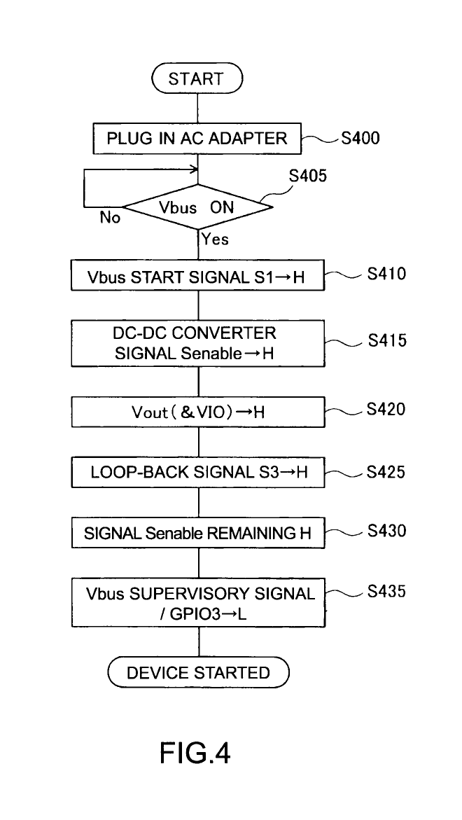

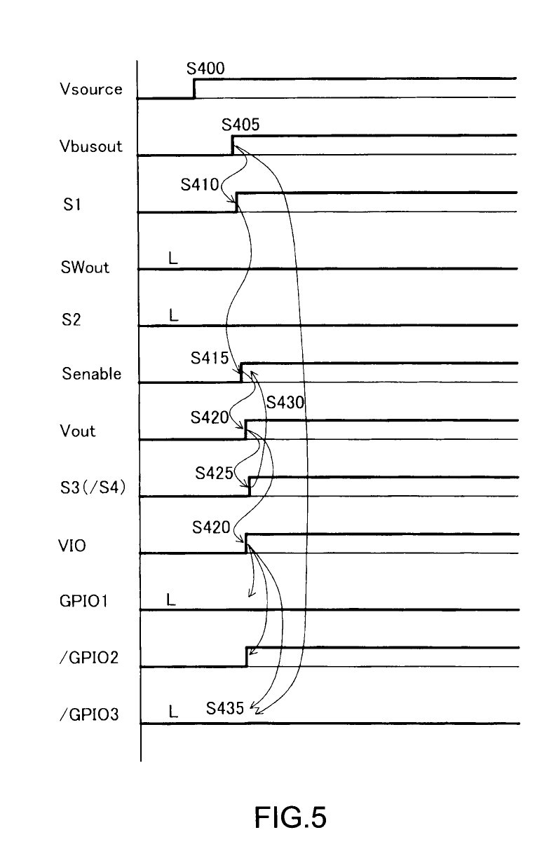

Next, an operation of the wireless Ethernet converter 20 of the present embodiment is described. First of all, there is described a type of start-up using Vbus as a trigger when the USB-interlocking changeover switch 245 (also referred to as a Vbus-synchronized switch, hereunder) is synchronized with USB, i.e., when the input terminal 245a and the output terminal 245b are conductively connected to one another (also referred to as Vbus-synchronized state, hereunder). FIG. 4 is a flow chart describing a type of Vbus trigger start-up under a condition of Vbus-synchronization. FIG. 5 is a timing chart describing this type of Vbus trigger start-up under the condition of Vbus-synchronization.

At a step S400 in FIG. 4, a DC plug (not shown) of the AC adapter 23 (FIG. 1) is plugged into the DC jack 210, thus causing the voltage Vsource to reach H level as shown in FIG. 5.

At a step S405 in FIG. 4, the bus power supplied from the TV 10 (FIG. 1) is outputted from the output terminal 245b (FIG. 2) through the USB connector 240 as well as the USB-interlocking changeover switch 245. Namely, as shown in FIG. 5, the signal Vbusout reaches H level.

At a step S410 in FIG. 4, when the signal Vbusout is at H level, the start signal generating circuit 262 serves to output the Vbus start signal S1 of H level (FIG. 5). Since the Vbus start signal S1 is at H level, the node Ny (FIG. 3) also reaches H level, thereby causing the enable signal Senable to reach H level (FIG. 5) in a step S415. This enable signal Senable is then inputted into the EN terminal of the DC-DC converter 220 (FIG. 3).

Further, when the enable signal Senable is at H level, the voltage Vout outputted from the output terminal VOUT of the DC-DC converter 220 reaches H level as well (FIG. 5), At a step S420 in FIG. 4. Furthermore, since the voltage Vout outputted from the output terminal VOUT is at H level, a voltage of the internal power supply VIO inputted into the CPU 200 also reaches H level (FIG. 5), according to the step S420 in FIG. 4.

At a step S425 in FIG. 4, since the aforementioned voltage Vout is at H level, the loop-back signal S3 reaches H level as well (FIG. 5). As a result, At a step S430 in FIG. 4, the enable signal Senable is allowed to remain activated (H) (FIG. 5). In this way, the DC-DC converter 220 is allowed to keep outputting the voltage Vout (FIG. 5).

Here, as shown in FIG. 3, the internal power supply VIO serves as a power supply not only for the CPU 200, but also for the Vbus signal detection circuit 264, the power switch detection circuit 274 and the power supply shutdown circuit 284. In this sense, the power supply shutdown signal GPIO1, the power SW supervisory signal /GPIO2 and the Vbus supervisory signal /GPIO3 remain at L level until the internal power supply VIO has reached H level. Particularly, the power supply shutdown signal GPIO1, the power SW supervisory signal /GPIO2 and the Vbus supervisory signal /GPIO3 respectively exhibit the following behaviors when the internal power supply VIO has reached H level.

The power supply shutdown signal GPIO1 is one of the outputs from the CPU 200, and is determined by an operation of the internal circuit of the CPU 200. According to the present embodiment, the circuit of the CPU 200 or a control program (not shown) of the CPU is so configured that the power supply shutdown signal GPIO1 reaches L level right after the internal power supply VIO has reached H level. Accordingly, the power supply shutdown signal GPIO1 remains at L level.

The power SW supervisory signal /GPIO2 is outputted from the power switch detection circuit 274. When the internal power supply VIO is at H level, the signal SWout inputted into the base of the transistor Tr2 (FIG. 3) reaches L level, thereby preventing a collector-emitter current of the transistor Tr2 from flowing, and thus causing the power SW supervisory signal /GPIO2 to be transited to H level from L level.

The Vbus supervisory signal /GPIO3 is outputted from the Vbus signal detection circuit 264. When the internal power supply VIO is at H level, the signal Vbusout inputted into the base of the transistor Tr3 also reaches H level, thereby causing the collector-emitter current of transistor Tr3 to flow. Therefore, At a step S435 in FIG. 4, the Vbus supervisory signal /GPIO3 remains at L level (FIG. 5).

In this way, once the bus power from the TV 10 has been supplied to the USB connector 240 of the wireless Ethernet converter 20, the signal Vbusout inside the wireless Ethernet converter 20 reaches H level. The start signal generating circuit 262 is then caused to output the Vbus start signal S1 of H level so as to activate the enable signal Senable (H) inputted into the EN terminal of the DC-DC converter 220. Accordingly, the output voltage Vout from the DC-DC converter 220 reaches H level, thus causing the loop-back signal S3 to also reach H level. This loop-back signal S3 allows the enable signal Senable to remain activated. As a result, the wireless Ethernet converter 20 can be started by means of the bus power from the TV 10.

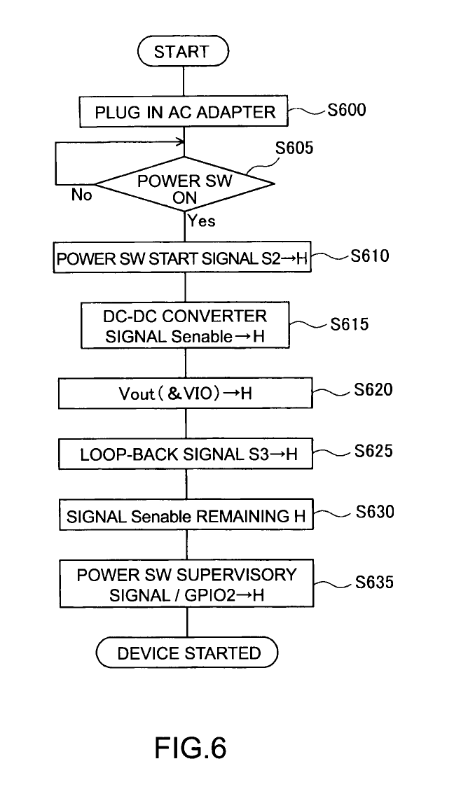

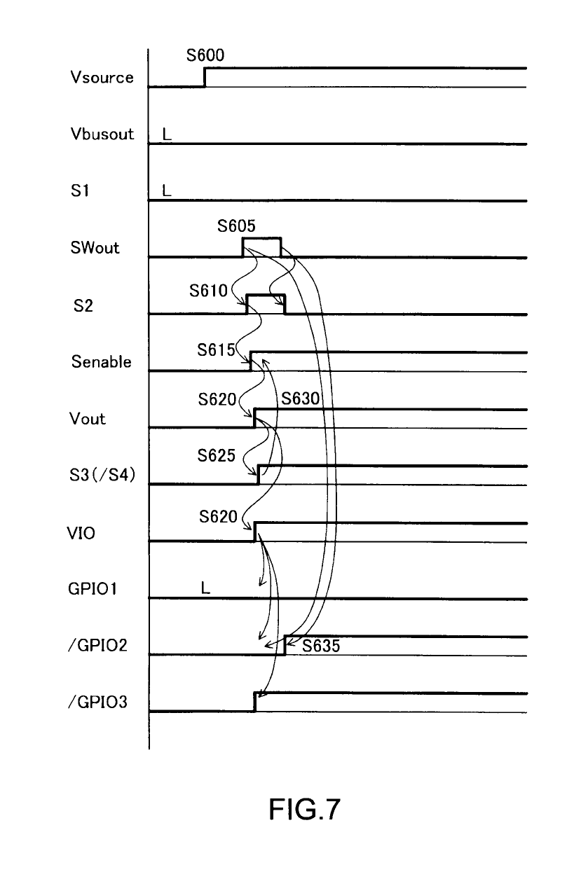

Actually, the wireless Ethernet converter 20 may be used as a wireless communication device even when the TV 10 is not started. In this sense, instead of performing start-up through the Vbus-synchronized state, it is preferred that the power switch 230 can also be used for start-up. There is described hereunder how the wireless Ethernet converter 20 is started when using the power switch 230 as a trigger and when the Vbus-synchronized switch is in the Vbus-synchronized state. FIG. 6 is a flow chart describing how the wireless Ethernet converter 20 is started by means of the power switch under the condition of Vbus-synchronization. FIG. 7 is a timing chart also describing how the wireless Ethernet converter 20 is started by means of the power switch under the condition of Vbus-synchronization.

At a step S600 in FIG. 6, the DC plug (not shown) of the AC adapter 23 (FIG. 1) is plugged into the DC jack 210. Accordingly, the voltage Vsource reaches H level as shown in FIG. 7. This procedure is identical to the step S400 in FIG. 4.

At a step S605 in FIG. 6, once the power button 230c of the power switch 230 (FIG. 3) has been pushed, the input terminal 230a and the output terminal 230b of the power switch 230 are conductively connected to one another, thereby allowing the output signal SWout of H level to be outputted from the output terminal 230b (FIG. 7). According to the present embodiment, the output signal SWout is at H level only when the power button 230c is being pushed.

At a step S610 in FIG. 6, since the output signal SWout is at H level, the start signal generating circuit 272 serves to output the power SW start signal S2 of H level (FIG. 7). This power SW start signal S2 of H level allows the enable signal Senable to also reach H level (FIG. 7), At a step S615 in FIG. 6.

At a step S620 in FIG. 6, since the enable signal Senable is at H level, the voltage Vout outputted from the output terminal VOUT of the DC-DC converter 220 also reaches H level (FIG. 7). And, when the voltage Vout outputted from the output terminal VOUT is at H level, the voltage of the internal power supply VIO inputted into the CPU 200 also reaches H level (FIG. 7), also according to the step S620 in FIG. 6.

At a step S625 in FIG. 6, when the voltage Vout is at H level, the loop-back signal S3 reaches H level as well (FIG. 7). As a result and At a step S630 in FIG. 6, the enable signal Senable is allowed to remain activated (FIG. 7). In this sense, the DC-DC converter 220 can keep outputting the voltage Vout even when the power SW start signal S2 has been transited to L level (FIG. 7). Here, the operations in the steps S620 through S630 in FIG. 6 are identical to those in the steps S420 through S430 in FIG. 4 describing the type of Vbus trigger start-up.

The behavior of the power supply shutdown signal GPIO1 in this case is identical to that in the case of the Vbus trigger start-up. Therefore, descriptions regarding the behavior of the power supply shutdown signal GPIO1 are omitted in this case.

The power SW supervisory signal /GPIO2 is outputted from the power switch detection circuit 274. The signal SWout is at H level when the power button 230c is being pushed. When the internal power supply VIO is at H level, the signal SWout inputted into the base of the transistor Tr2 (FIG. 3) also reaches H level, thereby causing the collector-emitter current of the transistor Tr2 to flow and the power SW supervisory signal /GPIO2 to remain at L level due to a voltage drop caused by the resistor 274a. However, the signal SWout reaches L level (FIG. 7) when the power button 230c is no longer being pushed. An operation in a step S635 in FIG. 6 is effected by a transition from the state in which the power button 230c is being pushed to the state in which the power button 230c is no longer being pushed. According to this step, the signal SWout inputted into the base of the transistor Tr2 (FIG. 3) reaches L level, thereby preventing the collector-emitter current of the transistor Tr2 from flowing, thus causing the power SW supervisory signal /GPIO2 to be transited to H level from L level (FIG. 7).

The Vbus supervisory signal /GPIO3 is outputted from the Vbus signal detection circuit 264. The signal Vbusout inputted into the base of the transistor Tr3 is at L level, thereby preventing the collector-emitter current of the transistor Tr3 (FIG. 3) from flowing even when the internal power supply VIO is at H level. Accordingly, the Vbus supervisory signal /GPIO3 is transited to H level from L level.

In this way, the signal SWout inside the wireless Ethernet converter 20 reaches H level when the power switch 230 of the wireless Ethernet converter 20 is turned on. Accordingly, the start signal generating circuit 272 serves to output the power SW start signal S2 of H level so as to activate the enable signal Senable (H) inputted into the EN terminal of the DC-DC converter 220. As a result, the output voltage Vout of H level is outputted from the DC-DC converter 220, thus causing the loop-back signal S3 to reach H level as well. This loop-back signal S3 allows the enable signal Senable to remain activated even when the power SW start signal S2 has reached L level. In this sense, the wireless Ethernet converter 20 can also be started by means of the power switch 230 other than the bus power from the TV 10. Particularly, it is preferred that the power button 230c of the power switch 230 is being pushed until the output voltage Vout from the DC-DC converter 220 and the loop-back signal S3 have successively reached H level.

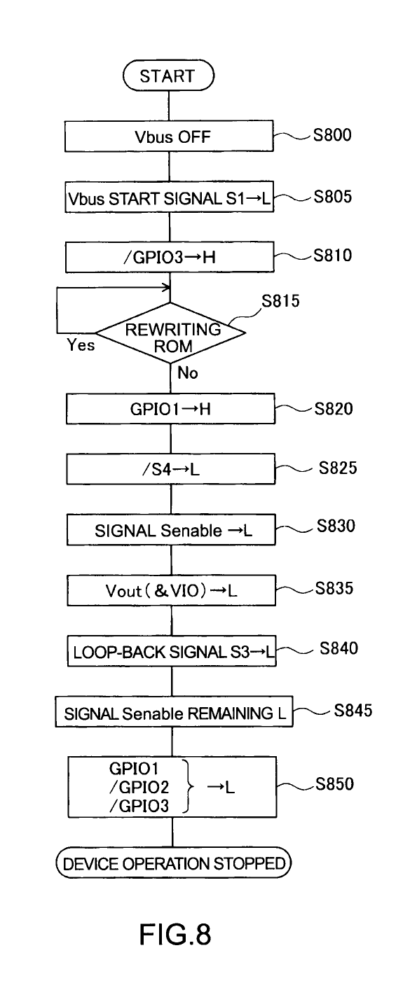

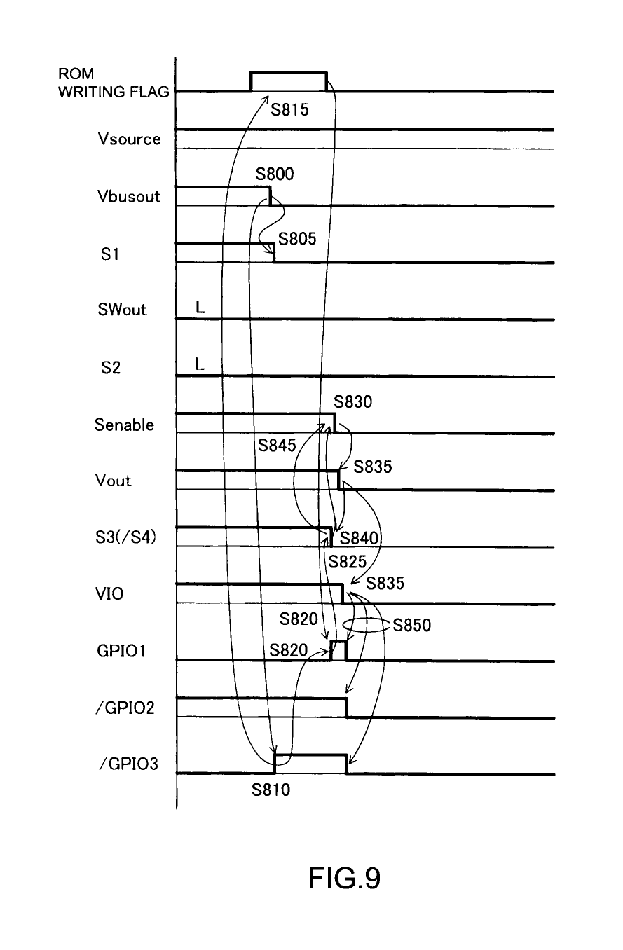

Next, there is described how the wireless Ethernet converter 20 is powered off by turning off the Vbus power supply from the TV 10. FIG. 8 is a flow chart showing how the wireless Ethernet converter 20 is powered off by turning off the Vbus power under the condition of Vbus-synchronization. FIG. 9 is a timing chart showing how the wireless Ethernet converter 20 is powered off by turning off the Vbus power under the condition of Vbus-synchronization.

According to the wireless Ethernet converter 20 which has been started by means of the Vbus power, the voltage Vsource supplied to the DC jack 210 (FIG. 1) is at H level as shown in FIG. 9. Further, the signal Vbusout is also at H level at that time. Furthermore, the output voltage Vout from the DC-DC converter 220 (FIG. 1) and the internal power supply VIO supplied to the CPU 200, the Vbus signal detection circuit 264, the power switch detection circuit 274 and the power supply shutdown circuit 284, are at H level at that time as well. In addition, the power supply shutdown signal GPIO1 is at L level, the power SW supervisory signal /GPIO2 is at H level and the Vbus supervisory signal /GPIO3 is at L level at that time (FIG. 5).

At a step S800 in FIG. 8, The Vbus power supply from the TV 10 (FIG. 1) is turned off (L). Accordingly, the signal Vbusout also reaches L level (FIG. 9). At a step S805 in FIG. 8, the start signal generating circuit 262 serves to output the Vbus start signal S1 of L level (FIG. 9). Here, the power SW start signal S2 is at L level.

At a step S810 in FIG. 8, since the base of the transistor Tr3 is at L level, the transistor Tr3 itself is turned off, thus causing the Vbus signal detection circuit 264 to output the Vbus supervisory signal /GPIO3 of H level (FIG. 9). At a step S815 in FIG. 8, after the Vbus supervisory signal /GPIO3 of H level has been outputted, the CPU 200 serves to determine whether or not the firmware is being rewritten. As described above, the CPU 200 can determine whether or not the firmware is being rewritten according to whether or not the writing flag 280 is activated (FIG. 2). If the firmware is not being rewritten, the CPU 200 outputs the power supply shutdown signal GPIO1 of H level (FIG. 9), At a step S820 in FIG. 8. However, if the firmware is being rewritten, the CPU 200 serves to output the power supply shutdown signal GPIO1 of H level (FIG. 9) after the corresponding firmware has been rewritten.

At a step S825 in FIG. 8, since the power supply shutdown signal GPIO1 is at H level, the power supply shutdown circuit 284 serves to output the power supply shutdown signal /S4 of L level (FIG. 9). Specifically, the signal of H level (power supply shutdown signal GPIO1) is inputted into the base of the transistor Tr1 of the power supply shutdown circuit 284, thereby causing the base-emitter current and the collector-emitter current of the transistor Tr1 to flow (FIG. 3). As a result, the power supply shutdown signal /S4 of L level is outputted from the collector of the transistor Tr1.

At a step S830 in FIG. 8, since the power supply shutdown signal /S4 is at L level, the enable signal Senable also reaches L level (FIG. 9). Here, at the time when the power supply shutdown signal /S4 reaches L level, both the Vbus start signal S1 (step S805 in FIG. 8) and the power SW start signal S2 are at L level (FIG. 9).

At a step S835 in FIG. 8, since the enable signal Senable is at L level, the DC-DC converter 220 (FIG. 3) serves to output the output voltage Vout of L level (FIG. 9) from the output terminal VOUT. Here, since the output voltage Vout is at L level, the internal power supply VIO of the CPU 200 also reaches L level (FIG. 9).

At a step S840 in FIG. 8, since the output voltage Vout from the DC-DC converter 220 is at L level, the loop-back signal S3 also reaches L level (FIG. 9). Accordingly, the enable signal Senable is allowed to remain at L level (FIG. 9) in a step S845. As a result, the output voltage Vout outputted from the output terminal VOUT is also allowed to remain at L level (FIG. 9).

At a step S850 in FIG. 8, since the internal power supply VIO is at L level, all the power supply shutdown signal GPIO1, the power SW supervisory signal /GPIO2 and the Vbus supervisory signal /GPIO3 reach L level (FIG. 9).

In this way, when the bus power supplied to the USB connector 240 of the wireless Ethernet converter 20 from the TV 10 is turned off, the Vbus start signal S1 reaches L level, and the Vbus supervisory signal /GPIO3 reaches L level as well. The CPU 200 determines whether or not the firmware is being rewritten by means of the writing flag 280, upon detecting that the Vbus supervisory signal /GPIO3 has reached L level. If the firmware is being rewritten, the CPU 200 serves to output the power supply shutdown signal GPIO1 of H level after the corresponding firmware has been rewritten. Accordingly, both the power supply shutdown signal /S4 and the enable signal Senable reach L level. As a result, the output voltage Vout outputted from the DC-DC converter 220 also reaches L level. Since the output voltage Vout is at L level, the loop-back signal S3 also reaches L level, thereby allowing the enable signal Senable to remain at L level. In this manner, the operation of the wireless Ethernet converter 20 can be stopped by turning off the bus power supplied to the USB connector 240 of the wireless Ethernet converter 20.

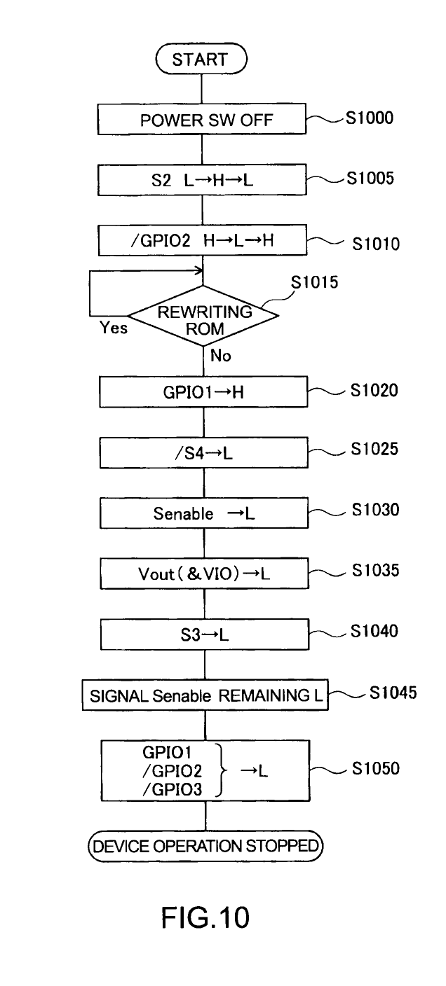

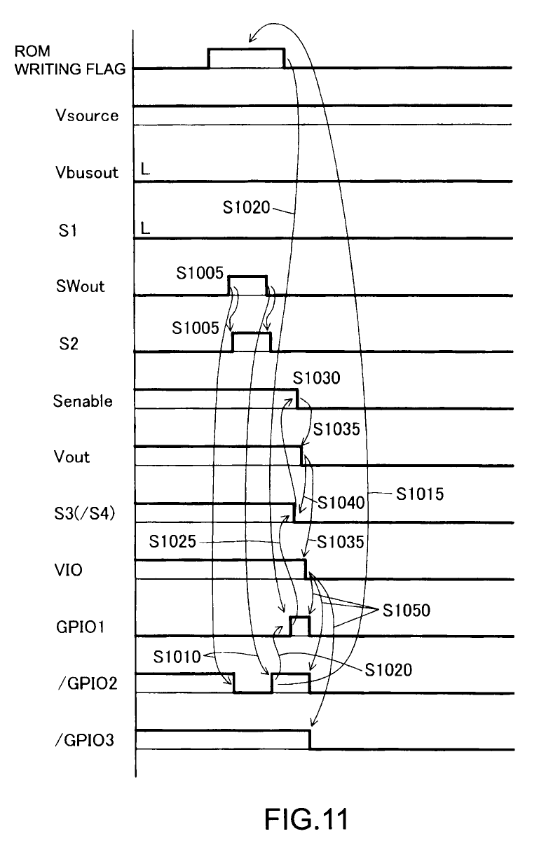

Next, there is described how the wireless Ethernet converter 20 is powered off by turning off the power switch 230 under the condition of Vbus-synchronization. FIG. 10 is a flowchart showing how the wireless Ethernet converter 20 is powered off when Vbus is at L level under the condition of Vbus-synchronization. FIG. 11 is a timing chart showing how the wireless Ethernet converter 20 is powered off when Vbus is at L level under the condition of Vbus-synchronization.

According to the wireless Ethernet converter 20 which has been started by means of the power switch 230, the voltage Vsource supplied to the DC jack 210 (FIG. 1) is at H level as shown in FIG. 11. Further, the signal Vbusout is at L level at that time. Furthermore, the output voltage Vout from the DC-DC converter 220 (FIG. 1) and the internal power supply VIO supplied to the CPU 200, the Vbus signal detection circuit 264, the power switch detection circuit 274 and the power supply shutdown circuit 284, are at H level at that time. In addition, the power supply shutdown signal GPIO1 is at L level, the power SW supervisory signal /GPIO2 is at H level and the Vbus supervisory signal /GPIO3 is at H level at that time (FIG. 7).

At a step S1000 in FIG. 10, the power button 230c (FIG. 3) is pushed, and the signal SWout is at H level only when the power button 230c is being pushed. Namely, the signal SWout is transited from L level to H level, and then to L level again (FIG. 11). According to the present embodiment, a falling edge of this signal SWout serves as a trigger. In this sense, the power switch 230 may also be an alternate on/off changeover switch, as long as the falling edge of the signal SWout is allowed to serve as a trigger. At a step S1005 in FIG. 10, the power SW start signal S2 from the start signal generating circuit 272 is transited from L level to H level, and then to L level again (FIG. 11). Here, the Vbus start signal S1 is at L level.

At a step S1010 in FIG. 10, since the signal SWout is transited from L level to H level, and then to L level again, the power SW supervisory signal /GPIO2 from the power switch detection circuit 274 is transited from H level to L level, and then to H level again (FIG. 11). At a step S1015 in FIG. 10, once the power SW supervisory signal /GPIO2 has been transited to H level from L level, the CPU 200 serves to determine whether or not the firmware is being rewritten. As described above, the CPU 200 can determine whether or not the firmware is being rewritten according to whether or not the writing flag 280 is activated. At a step S1020 in FIG. 10, if the firmware is not being rewritten, the CPU 200 outputs the power supply shutdown signal GPIO1 of H level (FIG. 11). However, if the firmware is being rewritten, the CPU 200 outputs the power supply shutdown signal GPIO1 of H level after the corresponding firmware has been rewritten (FIG. 11).

At a step S1025 in FIG. 10, since the power supply shutdown signal GPIO1 is at H level, the power supply shutdown circuit 284 outputs the power supply shutdown signal /S4 of L level (FIG. 11). Particularly, the signal of H level is inputted into the base of the transistor Tr1 of the power supply shutdown circuit 284, thereby causing the base-emitter current and the collector-emitter current of the transistor Tr1 to flow (FIG. 3). As a result, the power supply shutdown signal /S4 of L level is outputted from the collector of the transistor Tr1.

At a step S1030 in FIG. 10, since the power supply shutdown signal /S4 is at L level, the enable signal Senable also reaches L level (FIG. 11). Here, at the time when the power supply shutdown signal /S4 reaches L level, both the power SW start signal S2 (step S1005 in FIG. 10) and the Vbus start signal 51 are at L level (FIG. 11).

At a step S1035 in FIG. 10, since the enable signal Senable is at L level, the DC-DC converter 220 (FIG. 3) outputs the output voltage Vout of L level (FIG. 11) from the output terminal VOUT. Further, since the output voltage Vout is at L level, the internal power supply VIO of the CPU 200 also reaches L level (FIG. 11).

At a step S1040 in FIG. 10, since the output voltage Vout from the DC-DC converter 220 is at L level, the loop-back signal S3 also reaches L level (FIG. 11). Therefore, the enable signal Senable is allowed to remain at L level At a step S1045 (FIG. 11). Thus, the output voltage Vout outputted from the output terminal VOUT is also allowed to remain at L level (FIG. 11).

At a step S1050 in FIG. 10, since the internal power supply VIO is at L level, all the power supply shutdown signal GPIO1, the power SW supervisory signal /GPIO2 and the Vbus supervisory signal /GPIO3 reach L level (FIG. 11).

In this way, when the power switch 230 is turned off, both the power SW start signal S2 and the power SW supervisory signal /GPIO2 reach L level. The CPU 200 determines whether or not the firmware is being rewritten by means of the writing flag 280, upon detecting that the power SW supervisory signal /GPIO2 has reached L level. If the firmware is being rewritten, the CPU 200 serves to output the power supply shutdown signal GPIO1 of H level after the corresponding firmware has been rewritten. Accordingly, both the power supply shutdown signal /S4 and the enable signal Senable reach L level. As a result, the output voltage Vout outputted from the DC-DC converter 220 also reaches L level. Since the output voltage Vout is at L level, the loop-back signal S3 also reaches L level, thereby allowing the enable signal Senable to remain at L level. In this manner, the operation of the wireless Ethernet converter 20 can be stopped by turning off the power switch 230 of the wireless Ethernet converter 20.

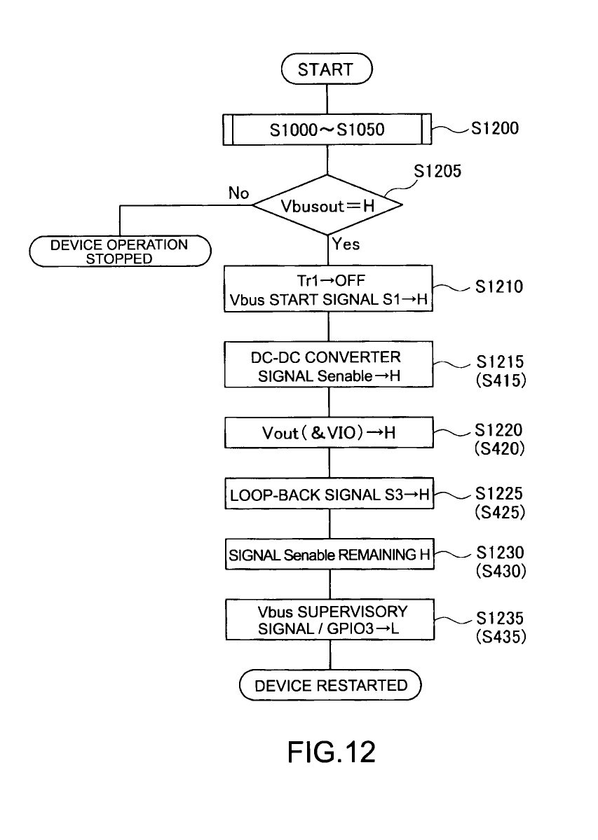

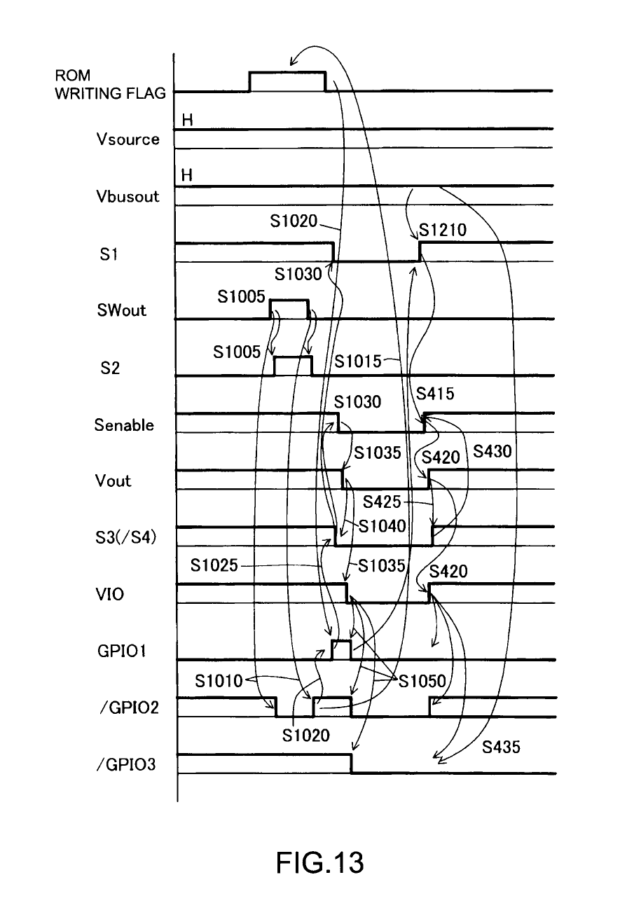

FIG. 12 is a flowchart showing how the wireless Ethernet converter 20 is powered off by turning off the aforementioned power switch when Vbus is at H level under the condition of Vbus-synchronization. FIG. 13 is a timing chart showing how the wireless Ethernet converter 20 is powered off by turning off the aforementioned power switch when Vbus is at H level under the condition of Vbus-synchronization.

Although Vbus is at H level in this case, the step S1000 through the step S1050 in FIG. 10 (subroutine S1200) are taken as are the case in which Vbus is at L level. Once the step S1050 has been taken, branches in the succeeding steps occur in terms of whether or not Vbusout is at H level at that moment, At a step S1205. Since the internal power supply VIO is at L level, the transistor Tr3 is turned off. Therefore, when Vbus is at H level, Vbusout also reaches H level. In this sense, a step S1210 is taken as the succeeding step. Here, when Vbus is at L level, Vbusout also reaches L level, and the operations concerning this condition have already been described using FIG. 10 and FIG. 11.

At a step S1210, since Vbusout is at H level, the power supply shutdown signal GPIO1 reaches L level, and the Vbus start signal S1 reaches H level when the transistor Tr1 is turned off. A step S1215 through a step S1235 are identical to the step S415 through the step S435 (FIG. 4, FIG. 5) concerning the type of Vbus trigger start-up. Namely, when the power switch 230 is turned off with the Vbus being at H level under the condition of Vbus-synchronization, the transistor Tr1 is turned on so that both the enable signal Senable and the voltage Vout from the DC-DC converter 220 reach L level. Subsequently, the power supply shutdown signal GPIO1 reaches L level so that the transistor Tr1 is turned off. Accordingly, since Vbusout is at H level, the start signal generating circuit 262 outputs the Vbus start signal 51 of H level, thereby causing the enable signal Senable to also reach H level. As a result, the voltage Vout outputted from the output terminal VOUT of the DC-DC converter 220 reaches H level as well. In this way, the wireless Ethernet converter 20 is restarted after once being powered off by turning off the power switch with Vbus being at H level under the condition of Vbus-synchronization.

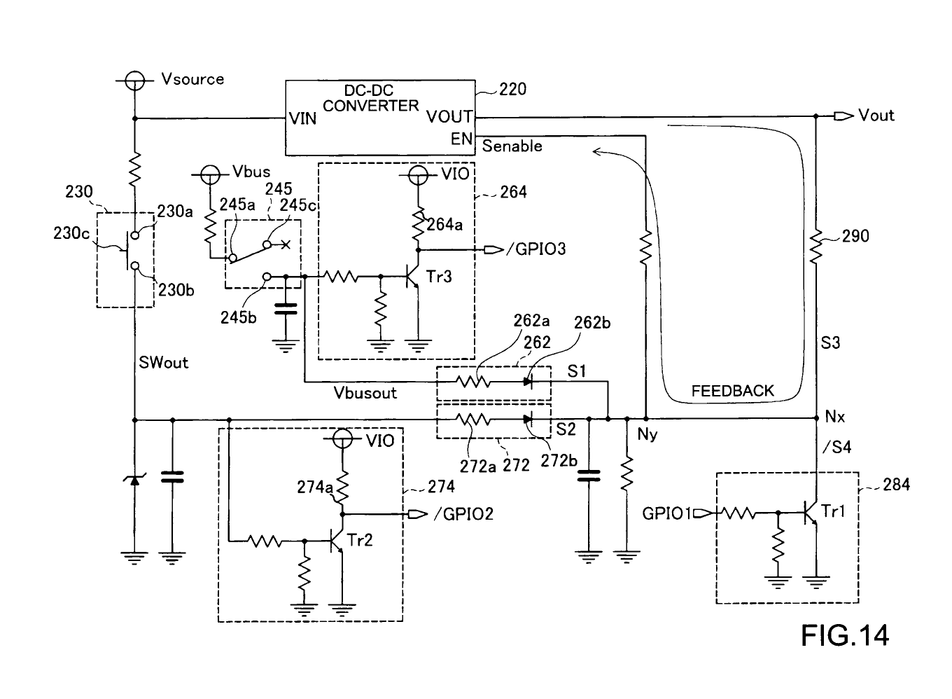

FIG. 14 is a diagram showing a section of a circuit of the wireless Ethernet converter 20 operated under a condition of Vbus non-synchronization. The USB-interlocking changeover switch 245 shown in FIG. 14 is different from the one shown in FIG. 3 in that the input terminal 245a thereof is connected to the output terminal 245c. In this sense, according to the circuit configuration shown in FIG. 14, the wireless Ethernet converter 20 is not turned on/off depending on the application of the bus power to the USB connector 240. Instead, the wireless Ethernet converter 20 in this case can only be turned on/off by means of the power switch 230. Such a kind of condition is referred to as the condition of Vbus non-synchronization, hereunder. Further, the base of the transistor Tr3 of the Vbus signal detection circuit 264 always remains at L level (FIG. 14). Accordingly, the wireless Ethernet converter 20 is started and stopped in the same manner as described above using the power switch. Thus, descriptions regarding such operations are omitted.

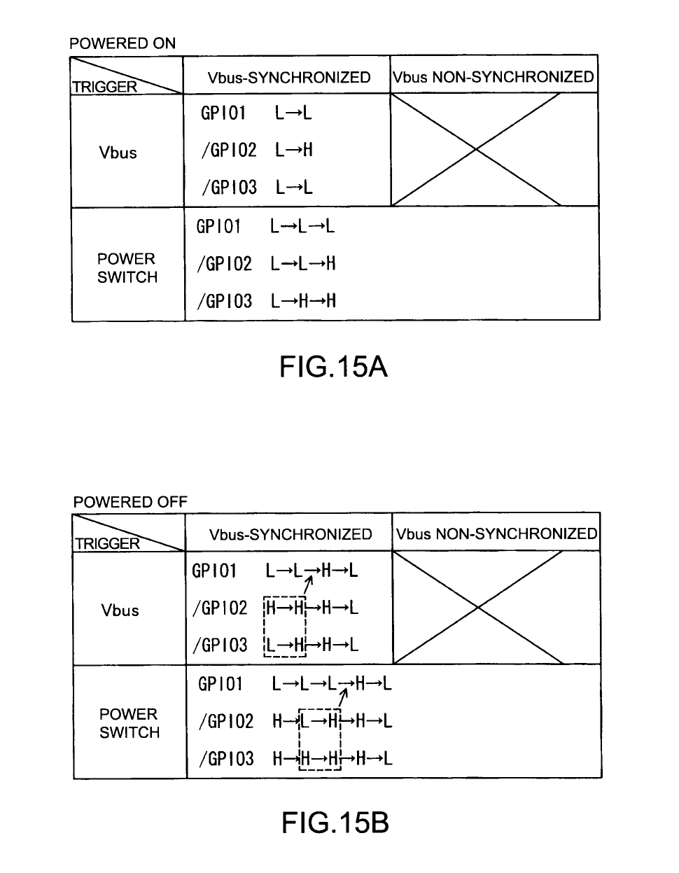

FIG. 15A and FIG. 15B are charts describing behaviors of the power supply shutdown signal GPIO1, the power SW supervisory signal /GPIO2 and the Vbus supervisory signal /GPIO3, when the wireless Ethernet converter 20 is powered on/off. FIG. 15A shows the corresponding behaviors when the wireless Ethernet converter 20 is powered on, while FIG. 15B shows the corresponding behaviors when the wireless Ethernet converter 20 is powered off. When the power is turned off, there is a timing at which any one of the power SW supervisory signal /GPIO2 and the Vbus supervisory signal /GPIO3 reaches L level with the other being at H level. Subsequently, both the power SW supervisory signal /GPIO2 and the Vbus supervisory signal /GPIO3 reach H level. Accordingly, from the state in which any one of the power SW supervisory signal /GPIO2 and the Vbus supervisory signal /GPIO3 is at L level with the other being at H level, the CPU 200 can simply cause the power supply shutdown signal GPIO1 to reach H level from L level at the moment when both the power SW supervisory signal /GPIO2 and the Vbus supervisory signal /GPIO3 reach H level.

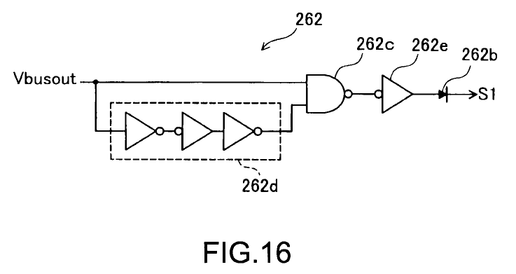

FIG. 16 is a diagram showing another configuration of the start signal generating circuit. According to this configuration, instead of the resistor 262a, the start signal generating circuit 262 includes a NAND circuit 262c, a delay inverter circuit 262d and an inverter circuit 262e. The delay inverter circuit 262d further includes an odd number of inverters. The signal Vbusout is inputted into one of the input terminals of the NAND circuit 262c, and an input terminal of the delay inverter circuit 262d. An output from the delay inverter circuit 262d is inputted into the other input terminal of the NAND circuit 262c. Further, an output from the NAND circuit 262c is inputted into the inverter circuit 262e connected to the NAND circuit 262c. This start signal generating circuit 262 is actually a one-shot pulse generating circuit. With the signal Vbusout remaining at L level, the NAND circuit 262c receives an input of H level at one input terminal thereof and an input of L level at the other input terminal thereof. Accordingly, the start signal generating circuit 262 serves to output the Vbus start signal S1 of L level. Particularly, the start signal generating circuit 262 instantaneously generates the Vbus start signal S1 as a pulse signal of H level (one-shot pulse) as the signal Vbusout is transited to H level from L level. The duration of such Vbus start signal S1 of H level is dependent on an amount of delay of the delay inverter circuit 262d. This amount of delay is preferably sufficient enough so that the Vbus start signal S1 of H level can be outputted until the loop-back signal S3 has reached H level. However, no pulse signal is generated as the signal Vbusout is transited to L level from H level. According to such configuration, the Vbus start signal S1 reaches L level after the wireless Ethernet converter 20 has been started through Vbus. Accordingly, the wireless Ethernet converter 20 can be powered off by means of the power switch 230 after being started through Vbus. Here, the start signal generating circuit 272 can employ the same configuration as such start signal generating circuit 262.

### Second Embodiment

The circuit configuration in the first embodiment prioritizes start-up through Vbus. Specifically, the USB-interlocking changeover switch 245 is in the Vbus-synchronized state, and it is difficult to power off the wireless Ethernet converter 20 by means of the power switch 230 when Vbus is at H level. A circuit configuration in a second embodiment prioritizes powering off through a power switch.

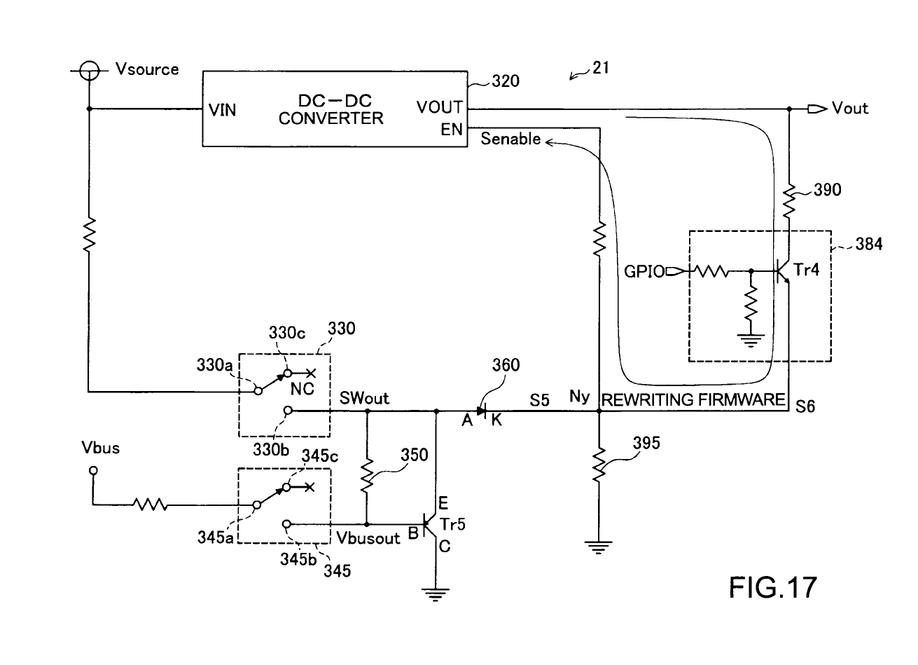

FIG. 17 is a diagram showing a section of a circuit of a wireless Ethernet converter of the second embodiment of the present invention. A wireless Ethernet converter 21 includes a power switch 330, a USB-interlocking changeover switch 345, a power conservation circuit 384, a diode 360, a transistor Tr5 and resistors 350, 395. Here, only elements not found in the first embodiment are described whereas the same elements as those in the first embodiment are given the same corresponding symbols and the descriptions thereof are omitted.

The power switch 330 includes an input terminal 330a and output terminals 330b, 330c. The power switch 330 allows the input terminal 330a and the output terminal 330b to be conductively connected to one another, or the input terminal 330a and the output terminal 330c to be conductively connected to one another. The input terminal 330a is connected to the DC jack 210 (FIG. 2), and the output terminal 330b is connected to an anode of the diode 360 and an emitter of the transistor Tr5. Here, a signal outputted form the output terminal 330b is also referred to as the “signal SWout” as is the case in the first embodiment. Further, the output terminal 330 is not connected to any of the elements.

The USB-interlocking changeover switch 345 includes an input terminal 345a and output terminals 345b, 345c. The USB-interlocking changeover switch 345 allows the input terminal 345a and the output terminal 345b to be conductively connected to one another, or the input terminal 345a and the output terminal 345c to be conductively connected to one another. The input terminal 345a is connected to the USB connector 240 (FIG. 2), and the output terminal 345b is connected to a base of the transistor Tr5. Here, a signal outputted from the output terminal 345b is also referred to as the “signal Vbusout” as is the case in the first embodiment. Here, the output terminal 345c is not connected to any of the elements. Further, the resistor 350 is connected between the output terminals 330b, 345b.

The transistor Tr5 is a PNP transistor. As described above, the signal Vbusout is inputted into the base of the transistor Tr5, and the signal SWout is inputted into the emitter thereof. A collector of the transistor Tr5 is connected to the ground. A cathode of the diode 360 is connected to an EN terminal of the DC-DC converter 320 through the node Ny. As described earlier, the signal SWout is inputted into the anode of the diode 360. Further, a signal S5 is outputted from the cathode of the diode 360. This signal S5 is then inputted into the EN terminal of the DC-DC converter 320 as the enable signal Senable, after passing through the node Ny.

The power conservation circuit 384 includes a transistor Tr4. A resistor 390 is provided between a collector of the transistor Tr4 and an output terminal VOUT of the DC-DC converter 320. A power conservation signal GPIO is inputted into a base of the transistor Tr4. Further, an emitter of the transistor Tr4 is connected to the node Ny. Once the power conservation signal GPIO has been activated (reached H level), the transistor Tr4 is turned on so as to output a power conservation signal S6 (H). As described above, the node Ny is connected to the EN terminal of the DC-DC converter 320, thereby causing the enable signal Senable to reach H level once the power conservation signal GPIO has been activated, thus allowing an output from the output terminal VOUT of the DC-DC converter 320 to remain at H level. Particularly, the power conservation signal GPIO remains at H level when the ROM 204 is having the aforementioned firmware rewritten. Namely, when the ROM 204 is having the firmware rewritten, the transistor Tr4 is turned on due to the power conservation signal GPIO so as to cause the enable signal Senable to reach H level, thus allowing the output from the output terminal VOUT of the DC-DC converter 320 to remain at H level. As a result, the wireless Ethernet converter 21 is not powered off when the ROM 204 is having the firmware rewritten.

The resistor 395 is connected to the node Ny and the ground. When the signal SWout from the power switch 330, the signal Vbusout from the USB-interlocking changeover switch 345 and the signal S6 from the power conservation circuit 384 are all at L level, the node Ny is caused to reach L level due to the resistor 395, thus causing the enable signal Senable to reach L level as well.

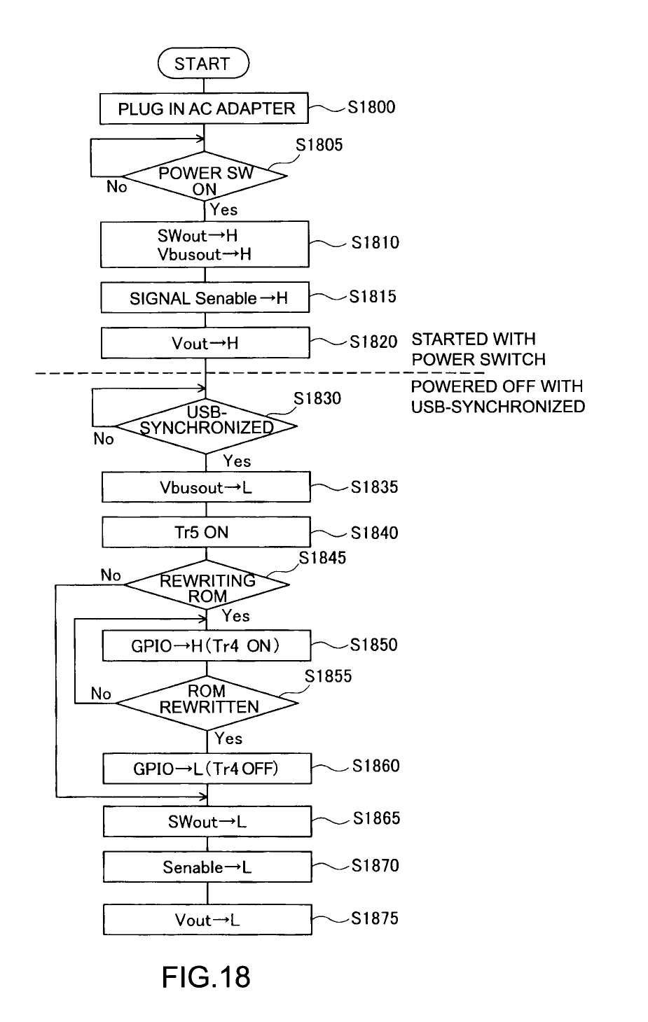

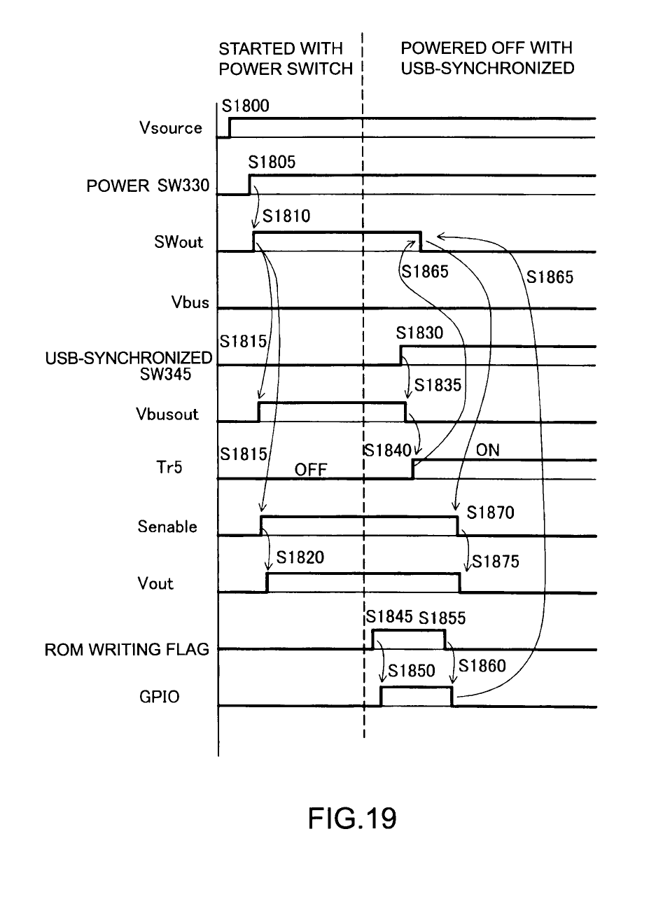

FIG. 18 is an operation flowchart of the second embodiment. FIG. 19 is a timing chart of the second embodiment. Here, there are described how the wireless Ethernet converter 21 is started by means of the power switch 330, and how the wireless Ethernet converter 21 is then powered off when the USB-interlocking changeover switch 345 has been switched to the Vbus-synchronized state from a Vbus non-synchronized state with Vbus being at L level initially.

In an initial state, the power switch 330 (FIG. 17) of the wireless Ethernet converter 21 is turned off (with the input terminal 330a and the output terminal 330c being conductively connected to one another). Further, the USB-interlocking changeover switch 345 is in the Vbus non-synchronized state (with the input terminal 345a and the output terminal 345c being conductively connected to one another). Furthermore, Vbus is at L level at that time.

At a step S1800 in FIG. 18, the DC plug (not shown) of the AC adapter 23 (FIG. 1) is plugged into the DC jack 210. In this way, the voltage Vsource reaches H level as shown in FIG. 19.

The output signal SWout from the output terminal 330b reaches H level (FIG. 19) in a step S1810 in FIG. 18, once the power switch 330 (FIG. 17) has been switched to an on-state (with the input terminal 330a and the output terminal 330b being conductively connected to one another) from an off-state (with the input terminal 330a and the output terminal 330c being conductively connected to one another) in a step S1805 in FIG. 18. As described above, the resistor 350 is connected between the output terminals 330b, 345b, thereby causing the signal Vbusout to also reach H level when the signal SWout is at H level. As a result, the potentials of the base and the emitter of the transistor Tr5 become substantially the same, thereby not causing a current to flow between the corresponding base and emitter, thus turning off the transistor Tr5. Namely, the signal SWout is not transited to L level due to the transistor Tr5. As described above, the transistor Tr5 is a PNP transistor with the base thereof being an N-type and the collector thereof being a P-type. Accordingly, no current is caused to flow from the base of the transistor Tr5 to the collector thereof, which is an adverse direction.

At a step S1815 in FIG. 18, the signal SWout of H level passes through the diode 360, causes the node Ny to reach H level and eventually serves to activate the enable signal Senable (H). At a step S1820 in FIG. 18, the activated enable signal Senable (H) allows the voltage Vout from the output terminal VOUT of the DC-DC converter 220 to reach H level (FIG. 19). In this way, the wireless Ethernet converter 21 can be started by means of the power switch 330.

Next, there are described operations of the wireless Ethernet converter 21 when the USB-interlocking changeover switch 345 has been switched to the Vbus-synchronized state from the Vbus non-synchronized state, such wireless Ethernet converter 21 having been started already by means of the power switch 330 as described above. In this case, Vbus is initially at L level.

At a step S1830, the USB-interlocking changeover switch 345 is switched to the Vbus-synchronized state from the Vbus non-synchronized state. Accordingly, the input terminal 345a of the USB-interlocking changeover switch 345 is conductively connected to the output terminal 345b thereof. Here, At a step S1835, since Vbus is at L level, the output signal Vbusout from the USB-interlocking changeover switch 345 is also at L level.

At a step S1840, the transistor Tr5 is turned on since Vbusout is at L level and since the signal SWout is at H level due to power supplied from Vsource. Once the transistor Tr5 has been turned on, the signal SWout undergoes transition to L level.

Here, At a step S1845, the CPU 200 serves to perform switchover of the process flow depending on whether or not the firmware is being rewritten (rewriting the ROM 204). As described in the first embodiment, the CPU 200 determines whether or not the firmware is being rewritten by means of the writing flag 280. When the firmware is being rewritten, the CPU 200 serves to activate the power conservation signal GPIO (H) so as to turn on the transistor Tr4 At a step S1850. As described above, the transistor Tr5 is turned on in the step S1840, thus causing the potentials of the signal SWout and eventually the node Ny to fall. However, the potential of the node Ny actually does not fall due to a current supplied from the transistor Tr4. Accordingly, the enable signal Senable remains at H level, thereby allowing the output from the output terminal VOUT of the DC-DC converter 320 to also remain at H level, thus preventing the wireless Ethernet converter 21 from being powered off.

Once the firmware has been rewritten in a step S1855, the CPU 200 serves to inactivate the power conservation signal GPIO (L) so as to turn off the transistor Tr4 in a step S1860. Accordingly, since the transistor Tr5 has been turned on in the step S1840, the potentials of the signal SWout and eventually the node Ny fall in a step S1865. As a result and At a step S1870, the enable signal Senable reaches L level. At a step S1875, the output from the output terminal VOUT of the DC-DC converter 320 reaches L level, thus powering off the wireless Ethernet converter 21. Here, if the firmware is not being rewritten in the step S1845, operations in the succeeding steps S1855 through S1860 are not performed. Instead, the step S1865 is taken as the succeeding step.

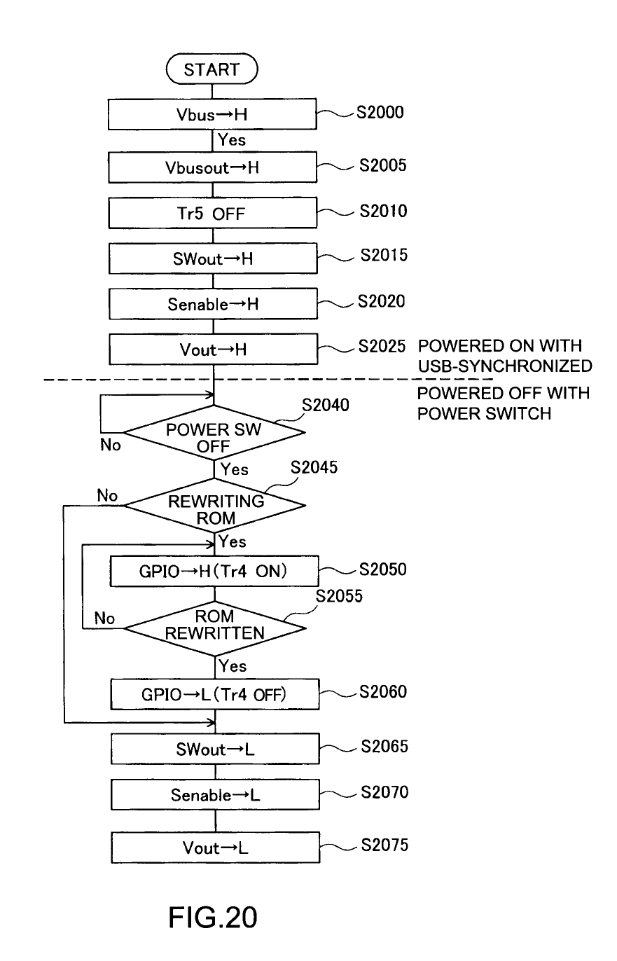

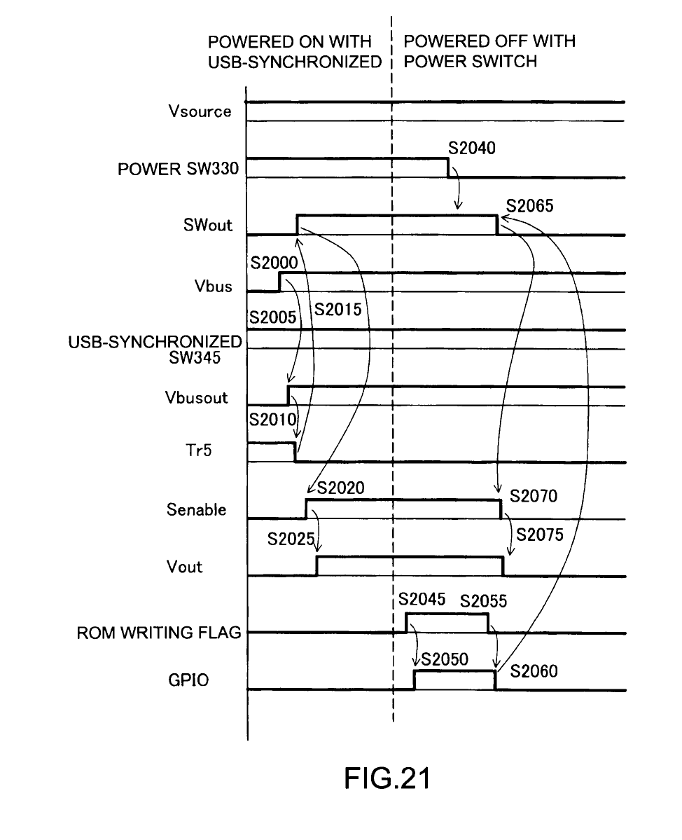

FIG. 20 is an operation flowchart of the second embodiment. FIG. 21 is a timing chart of the second embodiment. Here, there are described how the wireless Ethernet converter 21 is started by activating the Vbus power (H), and how the wireless Ethernet converter 21 is then powered off by means of the power switch 330. An initial state in those flowchart and timing chart is identical to a state upon completion of the operation in the step S1875 in FIG. 18.

At a step S2000 in FIG. 20, Vbus reaches H level once the Vbus power has been supplied from the TV 10 (FIG. 1). Next, At a step S2005, a signal of H level is then outputted from the output terminal 345b (FIG. 17) through the USB connector 240 (FIG. 1) and the USB-interlocking changeover switch 345. Specifically, the signal Vbusout reaches H level as shown in FIG. 21.

At a step S2010, the potential of the base of the transistor Tr5 becomes higher than the potential of the emitter thereof, thus turning off the transistor Tr5. Here, the output terminal 330b of the power switch 330 and the output terminal 345b of the USB-interlocking changeover switch 345 are connected to one another through the resistor 350. Accordingly, after the transistor Tr5 has been turned off, the signal SWout reaches H level in a step S2015 due to the current supplied by the signal Vbusout.

At a step S2020, since the signal SWout is at H level, a current is caused to flow into the node Ny through the diode 360, thereby allowing the enable signal Senable to reach H level. At a step S2025, the DC-DC converter 320 is activated so as to output the voltage Vout of H level from the output terminal VOUT thereof, as shown in FIG. 21.

Next, there are described operations when the power switch 330 is turned off. At a step S2040, the output terminal 330b is turned into an open state once the power switch 330 has been turned off (with the input terminal 330a and the output terminal 330c being conductively connected to one another). The potential of the signal SWout is determined by a current flowing from Vbus through the resistor 350, a current flowing into the ground through the diode 360 and the resistor 395, and a current supplied from the power conservation circuit 384. Here, the power conservation circuit 384 functions only when the firmware is being rewritten, thereby allowing the current supplied therefrom to be ignored. Further, the signal SWout can be recognized as L level if the resistances of the resistors 350 and 395 are set to be so large that the signal SWout is actually recognized as L level when the power switch 330 has been turned off.

At a step S2045, the CPU 200 serves to perform switchover of the process flow depending on whether or not the firmware is being rewritten (rewriting the ROM 204). The operations in the steps S2045 through S2060 are identical to those in the steps S1845 through S1860 in FIG. 18. Therefore, descriptions regarding such operations are omitted.

When the firmware is not being rewritten (“No” in the step S2045), or when the power conservation signal GPIO has been inactivated (L) (step S2060) upon completion of rewriting the firmware, there is no current supplied from the power conservation circuit 384, thus causing the signal SWout to be recognized as L level in a step S2065. Next, the enable signal Senable reaches L level in a step S2070, and the voltage Vout from the output terminal VOUT of the DC-DC converter 220 reaches L level in a step S2075, thus powering off the wireless Ethernet converter 21.

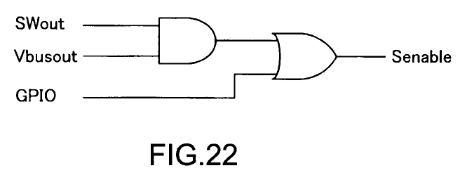

FIG. 22 is a diagram showing correlations among the signal SWout, the signal Vbusout, the power conservation signal GPIO and the enable signal Senable. According to the second embodiment, the enable signal Senable reaches H level when both the signal SWout and the signal Vbusout are at H level or when the power conservation signal GPIO is at H level (while the firmware is being rewritten). Whether the signal SWout reaches H level or L level depends on the state of the power switch 330. Further, whether the signal Vbusout reaches H level or L level depends on the state of the USB-interlocking changeover switch 345 and the potential of Vbus. Namely, when the USB-interlocking changeover switch 345 is in the Vbus non-synchronized state, the level of the signal Vbusout (either H or L) is identical to that of the signal SWout. In contrast, when the USB-interlocking changeover switch 345 is in the Vbus-synchronized state, whether the signal Vbusout reaches H level or L level depends on the potential of Vbus.

In this way, according to the present embodiment, the wireless Ethernet converter 21 can be powered off by means of the power switch 330 prior to the USB-interlocking changeover switch 345. Further, according to the present embodiment, there is employed an alternate switch as the power switch 330, and the state of the power of the wireless Ethernet converter 21 can be maintained depending on the state of such power switch 330. Furthermore, unlike the first embodiment, the CPU 200 does not need to monitor the states of the power switch 330 and the USB-interlocking changeover switch 345, but only serves to monitor whether or not the firmware is being rewritten. Accordingly, the power circuit of the wireless Ethernet converter 21 is allowed to have a simple configuration in this case.

### Modified Embodiment of the Second Embodiment

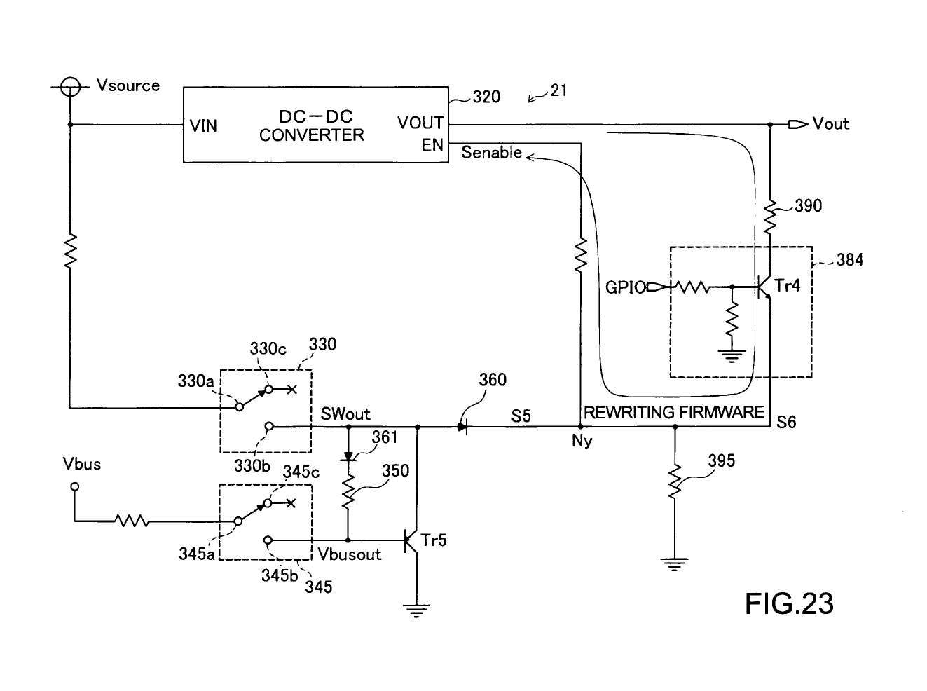

FIG. 23 is a diagram showing a modified embodiment of the second embodiment of the present invention. According to this modified embodiment, there is provided a diode 361 serially connected to the resistor 350 of the second embodiment (FIG. 17). An anode of the diode 361 is connected to the output terminal 330b of the power switch 330, and a cathode thereof is connected to the resistor 350. Here, both the diode 361 and the resistor 350 may be disposed on the output terminal 330b side.

The diode 361 thus provided serves to prevent an adverse current from flowing into the output terminal 330b so as to prevent the signal SWout from being transited to H level, even after the signal Vbusout has reached H level as a result of the potential of Vbus reaching H level and the USB-interlocking changeover switch 345 being turned on subsequently (with the input terminal 345a and the output terminal 345b being conductively connected to one another). As a result, the signal SWout reaches L level due to the resistor 395, thus making it possible to further reliably prioritize the power switch 330.

### Third Embodiment

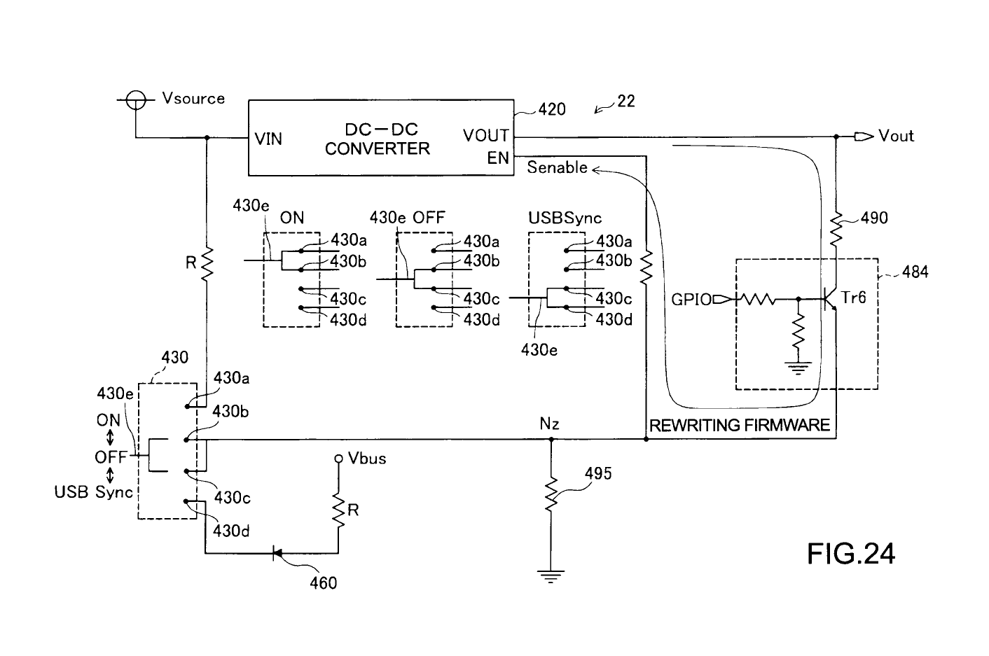

FIG. 24 is a diagram showing a third embodiment of the present invention. According to the third embodiment, there is provided a three-state slide switch 430. This three-state slide switch 430 is switched over between three states including a power-off state, a power-on state and a USB-interlocking/synchronized state (USB Sync). Specifically, the three-state slide switch 430 has four terminals including terminals 430a through 430d, and a switch 430e. The switch 430e serves to connect two neighboring terminals (any one of three pairs including a pair of the terminal 430a and the terminal 430b, a pair of the terminal 430b and the terminal 430c and a pair of the terminal 430c and the terminal 430d). Here, in the center of FIG. 24, there are shown positions of the switch 430e connecting the corresponding three pairs of the terminals.

The terminal 430a is connected to the DC jack 210 (FIG. 2) so that Vsource is applied thereto. The terminal 430d is connected to the USB connector 240 (FIG. 2) so that Vbus is applied thereto. The rest two terminals 430b and 430c are connected to a node Nz which is connected to an EN terminal of a DC-DC converter 420. Further, a resistor 495 is connected between the node Nz and the ground. As is the case in the second embodiment, the third embodiment also includes a power conservation circuit 484 for supplying power to the node Nz when the firmware is being rewritten.

The switch 430e serves to short-circuit the terminal 430b and the terminal 430c in the power-off state. The node Nz is at L level at that time since no circuit is supplying current thereto at that moment. Namely, a current is supplied to the node Nz from the power conservation circuit 484 only when the firmware is being rewritten, i.e., when the power has already been turned on. Accordingly, no current is supplied from the power conservation circuit 484 when a wireless Ethernet converter 22 is powered off. Further, since the node Nz is at L level, the enable signal Senable also reaches L level, thereby preventing the wireless Ethernet converter 22 from being powered on.

Next, the three-state slide switch 430 is switched over to the power-on state. The switch 430e serves to short-circuit the terminal 430a and the terminal 430b in the power-on state. Accordingly, Vsource is outputted from the terminal 430b. In this way, the node Nz and eventually the enable signal Senable reach H level, thereby allowing an output of H level to be outputted from the output terminal VOUT of the DC-DC converter 420, and thus powering on the wireless Ethernet converter 22.

Next, the three-state slide switch 430 is switched over to the power-off state. The switch 430e serves to short-circuit the terminal 430b and the terminal 430c in the power-off state. The node Nz is transited to L level since the node Nz is connected to the ground through the resistor 495. Particularly, since the current is supplied to the node Nz from the power conservation circuit 484 when the firmware is being rewritten, the node Nz is actually transited to L level after the firmware has been rewritten. Once the node Nz has been transited to L level, the enable signal Senable also reaches L level, thereby causing an output of L level to be outputted from the output terminal VOUT of the DC-DC converter 420, and thus powering off the wireless Ethernet converter 22. Here, when the three-state slide switch 430 is in either the power-on state or the power-off state, whether the wireless Ethernet converter 22 can be powered on/off does not depend on the level of Vbus since Vbus is not connected to the node Nz in the corresponding states.

Next, there is described a case in which the three-state slide switch 430 is in the USB-interlocking state (USB Sync state). The switch 430e serves to short-circuit the terminal 430c and the terminal 430d in the USB-interlocking state. In this case, whether the node Nz reaches H level or L level depends on whether Vbus is at H level or L level. Namely, when Vbus is at H level, the node Nz and eventually the enable signal Senable also reach H level, thereby allowing the output of H level to be outputted from the DC-DC converter 420, and thus powering on the wireless Ethernet converter 22. However, when Vbus is at L level, the node Nz and eventually the enable signal Senable also reach L level, thus powering off the wireless Ethernet converter 22. Further, if the firmware is being rewritten, the node Nz and eventually the enable signal Senable are then transited to L level as described above after the firmware has been rewritten, thus powering off the wireless Ethernet converter 22.

Here, the three-state slide switch 430 is switched over from the USB-interlocking state to the power-off state in the same way as it is switched over from the power-on state to the power-off state.

According to the present embodiment, the three-state slide switch 430 can not be directly switched over from the USB-interlocking state to the power-on state, or from the power-on state to the USB-interlocking state. Instead, the three-state slide switch 430 needs to be once switched over to the power-off state along the way. Particularly, during the process of switching over the three-state slide switch 430 to the power-on state from the USB-interlocking state, if Vbus is at H level, the wireless Ethernet converter 22 is once powered off when the three-state slide switch 430 has been switched over to the power-off state, and is then restarted when the three-state slide switch 430 has been switched over to the power-on state. If Vbus is at L level, it means that the wireless Ethernet converter 22 is powered off from the beginning. Therefore, the wireless Ethernet converter 22 is powered on when the three-state slide switch 430 has been switched over to the power-on state. According to the present embodiment, if Vbus is at H level, the wireless Ethernet converter 22 is once powered off when the three-state slide switch 430 has been switched over to the power-off state. However, a capacitor can be connected between the node Nz and the ground. In this case, if the three-state slide switch 430 is in the power-off state for a short period of time, it is less likely that the node Nz is transited to L level due to the charge stored in the corresponding capacitor. Accordingly, if the three-state slide switch 430 can be switched over to the power-on state before the node Nz has been recognized as L level, the three-state slide switch 430 can then be switched over with the wireless Ethernet converter 22 remaining powered on. Here, the process of switching over the three-state slide switch 430 to the USB-interlocking state from the power-on state shares the same characteristics as described above.

The peripheral device of the present invention and the control method thereof are not specifically limited to the aforementioned embodiments. As a matter of fact, various modified embodiments are possible. For example, although the wireless Ethernet converter is employed as a peripheral device in each one of the aforementioned embodiments, there can actually be employed other devices as peripheral devices. Such devices may include an external memory device, a media player, a network recorder, a network communication device, a tuner, a NAS (network attached storage), a set-top box or the like, as long as they can be connected to a host device. According to the aforementioned embodiments, there is employed the USB cable having the bus power line. However, other than the USB cable, there can be employed, for example, a 6-pin IEEE 1394 cable to connect a host device and a peripheral device. More specifically, any cable with a bus power line can be employed. Further, according to the present embodiments, only the bus power line and the GND line are used. Accordingly, conversion connectors can be used to overcome differences in connector shapes, thereby allowing various kinds of cables to be employed. For example, even if the host device employs the 6-pin IEEE 1394 cable as an output cable thereof, the peripheral device can be synchronized with this host device in terms of power-on/off by means of a IEEE 1394/USB conversion connector.

The present invention has thus far been described based on the aforementioned embodiments. However, the aforementioned embodiments are not to limit the present invention, but described to assist in understanding the present invention. In this sense, the present invention may be modified as well as improved within the scope of the gist thereof.

Here, there is described how the terms in the claims correspond to those in the embodiments. A connection cable in the claims corresponds to the USB cable 12 in the embodiments. Likewise, a first power terminal to the USB connector 240; a second power terminal to the DC jack 210; power circuits to the DC-DC converters 220, 320; a first start signal generating circuit to the start signal generating circuit 262; a second start signal generating circuit to the start signal generating circuit 272; first and second start signal generating circuits to the diode 360; a feedback circuit to the circuit starting from the VOUT terminals of the DC-DC converter 220, 320 to the EN terminals thereof through the nodes Nx, Ny; power switches to the power switches 230, 330 and the three-state slide switch 430; a power supply detection circuit to the Vbus signal detection circuit 264; a power switch-off detection circuit to the power switch detection circuit 274; a power supply shutdown circuit to the power supply shutdown circuit 284; a writing detection unit to the CPU 200 including the writing flag 280; changeover circuits to the Interlocking changeover switches 245, 345 and the three-state slide switch; and control units to the wireless Ethernet converters 20, 21 without the DC-DC converters 220, 320, respectively.

What is claimed:

1. A peripheral device capable of being connected to a host device through a connection cable including a power line, comprising:
a first power terminal capable of being connected to said power line of said connection cable;
a power circuit connected to a second power terminal different from said first power terminal to supply power to an internal circuit;
a first start signal generating circuit for generating a start signal causing said power circuit to start supplying power to said internal circuit, when power has been supplied to said first power terminal through said connection cable; and
a feedback circuit for allowing said start signal to remain activated when power has been supplied to said internal circuit from said power circuit.

2. The peripheral device according to claim 1, further comprising:
a power supply detection circuit for detecting power supply to said first power terminal; and
a power supply shutdown circuit for stopping said power circuit from supplying power to said internal circuit when said power supply detection circuit has detected that said first power terminal is no longer being supplied with power.

3. The peripheral device according to claim 1, further comprising:
a power switch; and
a second start signal generating circuit for generating a start signal causing said power circuit to start supplying power to said internal circuit, when said power switch has been turned on under a condition in which no power is being supplied to said first power terminal through said connection cable.

4. The peripheral device according to claim 3, further comprising:
a power switch-off detection circuit for detecting that said power switch is turned off; and
a power supply shutdown circuit for stopping said power circuit from supplying power to said internal circuit, when said power switch-off detection circuit has detected that said power switch is turned off under the condition in which no power is being supplied to said first power terminal through said connection cable.

5. The peripheral device according to claim 3, further comprising:
a power switch-off detection circuit for detecting that said power switch is turned off; and
a power supply shutdown circuit for stopping said power circuit from supplying power to said internal circuit, when said power switch-off detection circuit has detected that said power switch is turned off under a condition in which power is being supplied to said first power terminal through said connection cable.

6. The peripheral device according to claim 3, further comprising a changeover circuit for either allowing or not allowing power supply to said first power terminal to be detected.

7. The peripheral device according to claim 2, further comprising:
a rewritable nonvolatile memory; and
a writing detection unit for detecting whether or not said rewritable nonvolatile memory is being rewritten, wherein said power supply shutdown circuit serves to restrict an operation of said feedback circuit and stop said power circuit from supplying power to said internal circuit after said rewritable nonvolatile memory has been rewritten.

8. A peripheral device capable of being connected to a host device through a connection cable including a power line, comprising:
a first power terminal capable of being connected to said power line of said connection cable;
a power circuit connected to a second power terminal different from said first power terminal and for supplying power to an internal circuit; and
a control unit for causing said power circuit to start supplying power to said internal circuit when power has been supplied to said first power terminal through said connection cable, and for stopping said power circuit from supplying power to said internal circuit when said first power terminal is no longer being supplied with power.

9. The peripheral device according to claim 1, wherein said first power terminal is a USB power connector.

10. The peripheral device according to claim 1 is any one of an external memory device, a media player, a network recorder, a network communication device, a tuner, a Network Attached Storage and a set-top box.

11. A control method for controlling power on/off of a peripheral device capable of being connected to a host device through a connection cable including a power line, comprising:
a step of supplying power to a first power terminal of said peripheral device through said connection cable;
a step of generating a start signal causing a power circuit of said peripheral device to start supplying power to an internal circuit of said peripheral device, when power has been supplied to said first power terminal, said power circuit being connected to a second power terminal different from said first power terminal;
a step of allowing said power circuit of said peripheral device to start supplying power to said internal circuit of said peripheral device by means of said start signal; and
a step of allowing said start signal to remain activated when power has been supplied to said internal circuit from said power circuit.
